(19) United States
(12) Patent Application Publication
(10) Pub. No.: US 2024/0265260 A1
(43) Pub. Date: Aug. 8, 2024

(54) COMPRESSING NEURAL NETWORKS THROUGH UNBIASED MINIMUM VARIANCE PRUNING

(71) Applicant: Habana Labs Ltd., Caesarea (IL)

(72) Inventors: Brian Chmiel, Nesher (IL); Itay Hubara, Haifa (IL); Ron Banner, Yoqneam Ilit (IL)

(73) Assignee: Habana Labs Ltd., Caesarea (IL)

(21) Appl. No.: 18/164,875

(22) Filed: Feb. 6, 2023

(51) Int. Cl. G06N 3/082; G06N 3/0495

(52) U.S. Cl. CPC G06N 3/082; G06N 3/0495

(57) ABSTRACT

A DNN can be compressed by pruning one or more tensors for a deep learning operation. A first pruning parameter and a second pruning parameter are determined for a tensor. A vector having a size of the second pruning parameter may be extracted from the tensor. Pruning probabilities may be determined for the elements in the vector. One or more elements in the vector are selected based on the pruning probabilities. Alternatively, a matrix, in lieu of the vector, may be extracted from the tensor. Pruning probabilities may be determined for the columns in the matrix. One or more columns are selected based on their pruning probabilities. The number of the selected element(s) or column(s) may equal the first pruning parameter. The tensor can be modified by modifying the value(s) of the selected element(s) or column(s) and setting the value(s) of one or more unselected elements or columns to zero.

### TECHNICAL FIELD

This disclosure relates generally to neural networks, and more specifically, compressing deep neural networks (DNNs) through unbiased minimum variance pruning.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 illustrates an example convolution, in accordance with various embodiments.

FIG. 3 is a block diagram of a DNN system, in accordance with various embodiments.

FIG. 4 is a block diagram of a DNN module, in accordance with various embodiments.

FIG. 5 illustrates an example process of training an DNN, in accordance with various embodiments.

FIG. 6 is a block diagram of a compression module, in accordance with various embodiments.

FIG. 7 illustrates a MAC array, in accordance with various embodiments.

FIG. 8A illustrates a process of pruning a deep learning tensor with a 1:2 sparsity method, in accordance with various embodiments.

FIG. 8B illustrates a process of pruning a deep learning tensor with a 2:4 sparsity method, in accordance with various embodiments.

FIG. 8C illustrates a process of pruning a deep learning tensor with another 2:4 sparsity method, in accordance with various embodiments.

FIG. 8D illustrates a process of pruning a deep learning tensor with yet another 2:4 sparsity method, in accordance with various embodiments.

FIG. 9 illustrates another process of pruning a deep learning tensor with a 1:2 sparsity method, in accordance with various embodiments.

FIG. 10 is a flowchart showing a method of compressing a DNN, in accordance with various embodiments.

FIG. 11 is a flowchart showing another method of compressing a DNN, in accordance with various embodiments.

FIG. 12 is a block diagram of an example computing device, in accordance with various embodiments.

### DETAILED DESCRIPTION

### Overview

The last decade has witnessed a rapid rise in AI (artificial intelligence) based data processing, particularly based on DNN. DNNs are widely used in the domains of computer vision, speech recognition, image, and video processing mainly due to their ability to achieve beyond human-level accuracy. DNNs The significant improvements in DNN model size and accuracy coupled with the rapid increase in computing power of execution platforms have led to the adoption of DNN applications even within resource constrained mobile and edge devices that have limited energy availability.

However, the complex nature of DNN architectures (e.g., billions of parameters) makes it difficult to deploy them in real time. DNN models can require significantly large investment in compute resources and incur huge energy cost. Furthermore, the bandwidth required to load data into the DNN accelerator is a limiting factor when moving weights and activations between the on-chip memory and the MAC array. The significant computational complexity comes from the over parameterization of the DNN model, which builds in redundancy and provides an opportunity for optimization. These redundancies can be removed through various hardware and software techniques with little or no loss of accuracy and a significantly reduction in the amount of compute that needs to be performed.

Network-level compression is one of the currently available techniques employed to reduce the size of the neural network model with minimal loss to accuracy. Two popular network compression techniques are pruning and quantization. Neural network pruning is a technique of compression that removes weights from a trained model. The goal is to eliminate these weights without impacting the network performance and accuracy.

Pruning DNNs is one of the most effective and widely studied methods to improve DNN resource efficiency. Since DNNs are over-parametrized, many pruning technologies are focused on weights pruning to increase the sparsity level of the weights in the DNNs. Sparsity of activations and gradients have been studied too. Pruning a parameter (e.g., weight, activation, gradient, etc.) means changing the value of the parameter to zero so that computation on the parameter can be skipped. In some embodiments, zero valued parameters are not stored in memory. Thus, the currently available pruning technologies can reduce memory footprint to improve efficiencies of DNNs.

Unstructured pruning methods can achieve sparsity ratio with minimal or no accuracy degradation. However, the ability of unstructured pruning methods to actually reduce computational resources of modern hardware is limited. Structured pruning methods vary between coarse-grained and fine-grained methods. Coarse-grained methods, such as filter-wise or layer-wise pruning, are supported by hardware and software, but the sparsity ration range in which these methods can maintain the test accuracy is limited to significantly less than 50%. New hardware and software are developed to support N:M fine-grained structured sparsity. Specifically, they showed that 2:4 fine-grained structured sparsity, where two of every four contiguous elements are zero, can achieve up to ×2 improvement in a General Matrix Multiplication (GEMM) operation.

It is also possible to reduce compute footprint, e.g., by using pruning masks such as N:M fine-grained sparsity to accelerate matrix multiplication. In N:M fine-grained sparsity, N out of every M contiguous elements would be pruned for at least one of the two matrices involved in the matrix multiplication. In an example, 2:4 fine-grained sparsity can accelerate inference up to two times.

There may be three steps in training a DNN with N:M fine-grained sparsity: (1) train a dense model, (2) prune weights to obtain a N:M fixed sparsity mask, and (3) use the original training regime to re-train with the masked weights. In some other DNN pruning technologies, a DNN may be trained with an N:M mask in the third step without the first two steps. For instance, the training with the N:M mask can be done by using a straight-through estimator (STE) and additional regularization. These technologies usually keep a dense copy of the weights and set different weight decays rates to the masked and unmasked weights.

The process of training a DNN usually includes three phases: inference phase, backpropagation phase, and update phase. Each phase may require a GEMM for every DNN layer. Some pruning solutions accelerate the inference phase, but the backpropagation phase and update phase are kept dense. Some other solutions use a transposable mask, i.e., a mask that can be transposed and still match the N:M fine-grained structure to accelerate the backpropagation phase. Even though there are methods to find the optimal transposable mask efficiently, the currently available technologies for pruning DNNs cannot accelerate the update phase.

Embodiments of the present disclosure may improve on at least some of the challenges and issues described above by tensor-level pruning based on a minimum variable unbiased estimate (MVUE) pruning method. The MVUE pruning method can prune neural gradients (also referred to as “gradients”) in DNNs and therefore, can accelerate the update phase in the processing of training the DNNs.

In various embodiments of the present disclosure, a deep learning tensor is pruned based on a sparsity ratio. The deep learning tensor is a tensor to be used for a deep learning operation in a DNN. Examples of the deep learning operation include convolution (e.g., multiply-accumulate (MAC) operations, etc.), pooling operations, elementwise operations (e.g., elementwise addition, elementwise multiplication, etc.), other types of tensor operations, or some combination thereof. A tensor is a data structure having multiple data points (also referred to as “elements”) across one or more dimensions. Example tensors include a vector, which is a one-dimensional tensor, and a matrix, which is a two-dimensional (2D) tensor or a three-dimensional (3D) tensor. There can also be even higher dimensional tensors. The deep learning tensor may be a gradient tensor, an activation tensor, a weight tensor (e.g., a kernel or filter), and so on. The sparsity ratio may indicate a target sparsity level after the deep learning tensor is pruned. The sparsity ratio may be a ratio of a first pruning parameter to a second pruning parameter, such as N:M, where N is an integer that is no smaller than one and M is an integer that is greater than M.

In some embodiments, one or more vectors having the size of M may be extracted from the deep learning tensor and N element(s) are to be pruned from each of the vectors. The N element(s) can be selected from a vector by using the MVUE method, in which pruning probabilities are determined for the vector. In some embodiments, each pruning probability corresponds to a respective element in the vector and may equal the absolute value of the element divided the sum of all the elements' absolute values (i.e., the total absolute value of the vector). A reference probability may be predetermined. The reference probability may be in the range from 0 to 1. The N element(s) may be selected for being pruned based on at least one of the pruning probabilities of the vector and the reference probability.

In other embodiments (e.g., embodiments where the deep learning tensor is to be processed by a compute block in multiple cycles or by multiple compute blocks), one or more matrices having M columns and a plurality of rows may be extracted from the deep learning tensor, and the values in N columns in each matrix are to be pruned. Each matrix may be processed by a single compute block in a single cycle. The N column(s) can be selected from a matrix by using the MVUE method, in which pruning probabilities are determined for the matrix. In some embodiments, each pruning probability corresponds to a respective column in the matrix and may equal a norm (e.g., Euclidean norm) of the column divided the sum of all the column s′ norms (i.e., the total column of the matrix). The N column (s) may be selected for being pruned based on at least one of the pruning probabilities of the matrix and a predetermined reference probability.

Different from many currently available DNN pruning solutions, the present disclosure provides an unbiased minimum variance optimality criterion for pruning deep learning tensors, including gradient tensors. The present disclose also allow the use of N:M structured sparsity. The present disclosure can achieve small or even no degradation, which the currently available DNN pruning solutions fail to achieve. As the MVUE pruning method for N:M structured sparsity can be used to prune weights, activations, and gradients, the GEMMs in all the three training phases can potentially be accelerated. In some embodiments, a training phase can be accelerated by ×2 or above.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN

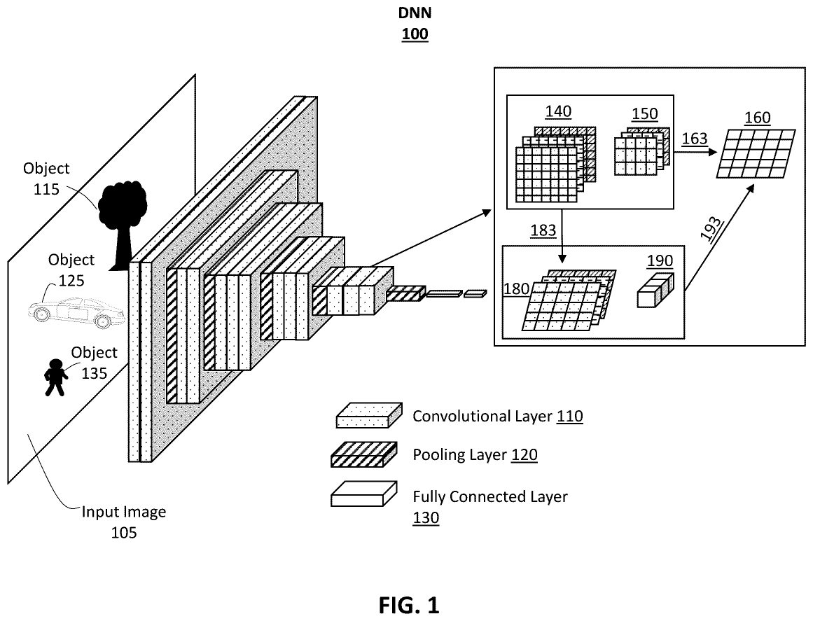

FIG. 1 illustrates an example DNN 100, in accordance with various embodiments. For purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as input feature map (IFM) 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

### Example Convolution

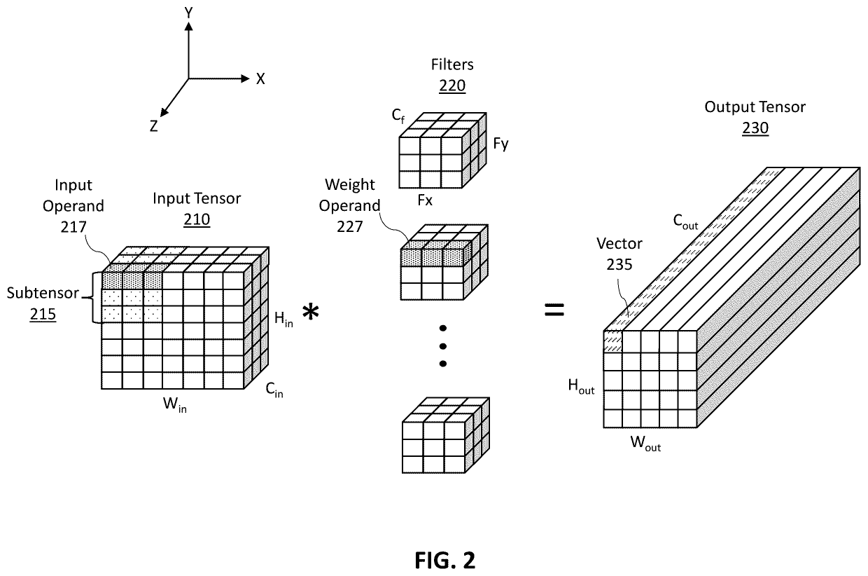

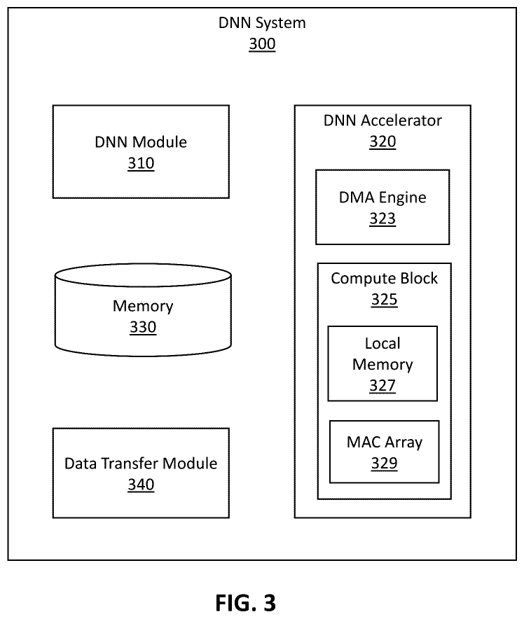

FIG. 2 illustrates an example convolution, in accordance with various embodiments. The convolution may be a convolution in a convolutional layer of a DNN, e.g., a convolutional layer 110 in FIG. 1. The convolutional layer may be a frontend layer. The convolution can be executed on an input tensor 210 and filters 220 (individually referred to as “filter 220”). A result of the convolution is an output tensor 230. In some embodiments, the convolution is performed by a DNN accelerator including one or more compute block. An example of the DNN accelerator may be the DNN accelerator 320 in FIG. 3. Examples of the compute blocks may be the compute blocks 325 in FIG. 3.

In the embodiments of FIG. 2, the input tensor 210 includes activations (also referred to as “input activations,” “elements,” or “input elements”) arranged in a 3D matrix. An activation in the input tensor 210 is a data point in the input tensor 210. The input tensor 210 has a spatial size Hᵢₙ×Wᵢₙ×Cᵢₙ, where Hᵢₙ is the height of the 3D matrix (i.e., the length along the Y axis, which indicates the number of activations in a column in the 2D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For purpose of simplicity and illustration, the input tensor 210 has a spatial size of 7×7×3, i.e., the input tensor 210 includes three input channels and each input channel has a 7×7 2D matrix. Each input element in the input tensor 210 may be represented by a (X, Y, Z) coordinate. In other embodiments, the height, width, or depth of the input tensor 210 may be different.

Each filter 220 includes weights arranged in a 3D matrix. The values of the weights may be determined through training the DNN. A filter 220 has a spatial size H_{f}×W_{f}×C_{f}, where H_{f} is the height of the filter (i.e., the length along the Y axis, which indicates the number of weights in a column in each kernel), We is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 220 in FIG. 2 has a spatial size of 3×3×3, i.e., the filter 220 includes 3 convolutional kernels with a spatial size of 3×3. In other embodiments, the height, width, or depth of the filter 220 may be different. The spatial size of the convolutional kernels is smaller than the spatial size of the 2D matrix of each input channel in the input tensor 210.

An activation or weight may take one or more bytes in a memory. The number of bytes for an activation or weight may depend on the data format. For example, when the activation or weight has an integral format (e.g., INT8), the activation takes one byte. When the activation or weight has a floating-point format (e.g., FP16 or BF16), the activation or weight takes two bytes. Other data formats may be used for activations or weights.

In the convolution, each filter 220 slides across the input tensor 210 and generates a 2D matrix for an output channel in the output tensor 230. In the embodiments of FIG. 2, the 2D matrix has a spatial size of 5×5. The output tensor 230 includes activations (also referred to as “output activations,” “elements,” or “output element”) arranged in a 3D matrix. An activation in the output tensor 230 is a data point in the output tensor 230. The output tensor 230 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Cₒᵤₜ may equal the number of filters 220 in the convolution. Hₒᵤₜ and Wₒᵤₜ may depend on the heights and weights of the input tensor 210 and each filter 220.

As a part of the convolution, MAC operations can be performed on a 3×3×3 subtensor 215 (which is highlighted with dot patterns in FIG. 2) in the input tensor 210 and each filter 220. The result of the MAC operations on the subtensor 215 and one filter 220 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 215 and all the filters 220 are finished, a vector 235 is produced. The vector 235 is highlighted with slashes in FIG. 2. The vector 235 includes a sequence of output activations, which are arranged along the Z axis. The output activations in the vector 235 have the same (x, y) coordinate, but the output activations correspond to different output channels and have different Z coordinates. The dimension of the vector 235 along the Z axis may equal the total number of output channels in the output tensor 230.

After the vector 235 is produced, further MAC operations are performed to produce additional vectors till the output tensor 230 is produced. For instance, a filter 220 may move over the input tensor 210 along the X axis or the Y axis, and MAC operations can be performed on the filter 220 and another subtensor in the input tensor 210 (the subtensor has the same size as the filter 220). The amount of movement of a filter 220 over the input tensor 210 during different compute rounds of the convolution is referred to as the stride size of the convolution. The stride size may be 1 (i.e., the amount of movement of the filter 220 is one activation), 2 (i.e., the amount of movement of the filter 220 is two activations), and so on. The height and width of the output tensor 230 may be determined based on the stride size.

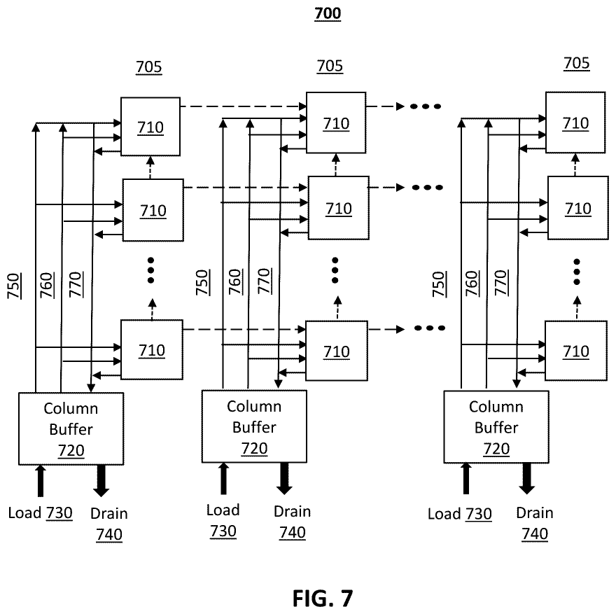

In some embodiments, the MAC operations on a 3×3×3 subtensor (e.g., the subtensor 215) and a filter 220 may be performed by a plurality of MAC units, such as the MAC units 710 in FIG. 7. One or more MAC units may receive an input operand (e.g., an input operand 217 shown in FIG. 2) and a weight operand (e.g., the weight operand 227 shown in FIG. 2). The input operand 217 includes a sequence of activations having the same (Y, Z) coordinate but different X coordinates. The weight operand 227 includes a sequence of weights having the same (Y, Z) coordinate but different X coordinates. The length of the input operand 217 is the same as the length of the weight operand 227. Activations in the input operand 217 and weights in the weight operand 227 may be sequentially fed into a PE. The PE may receive a pair of an activation and a weight at a time and multiple the activation and the weight. The position of the activation in the input operand 217 may match the position of the weight in the weight operand 227.

### Example DNN System

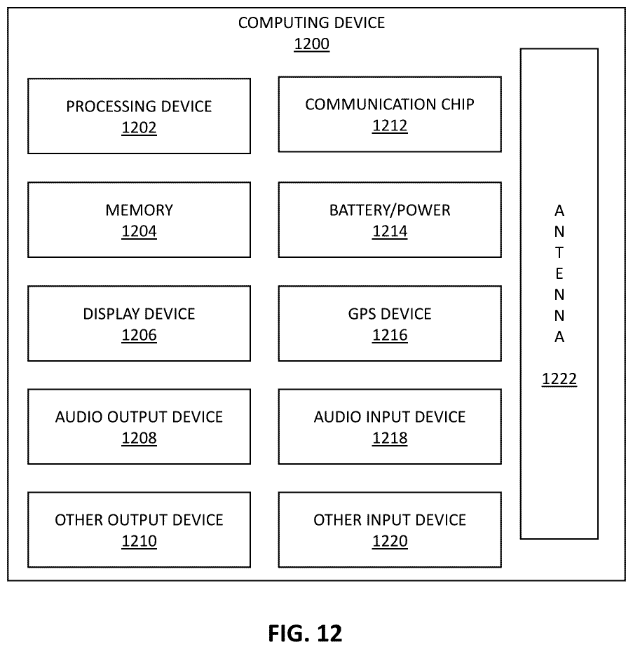

FIG. 3 is a block diagram of an example DNN system 300, in accordance with various embodiments. The whole DNN system 300 or a part of the DNN system 300 may be implemented in one or more computing devices, such as the computing device 1200 in FIG. 12. The DNN system 300 can generate and execute DNNs, such as the DNN 100 in FIG. 1. As shown in FIG. 3, the DNN system 300 includes a DNN module 310, a DNN accelerator 320, a memory 330, and a data transfer module 340. In other embodiments, alternative configurations, different or additional components may be included in the DNN system 300. For instance, the DNN system 300 may include multiple DNN accelerators or multiple memories. Further, functionality attributed to a component of the DNN system 300 may be accomplished by a different component included in the DNN system 300 or a different system.

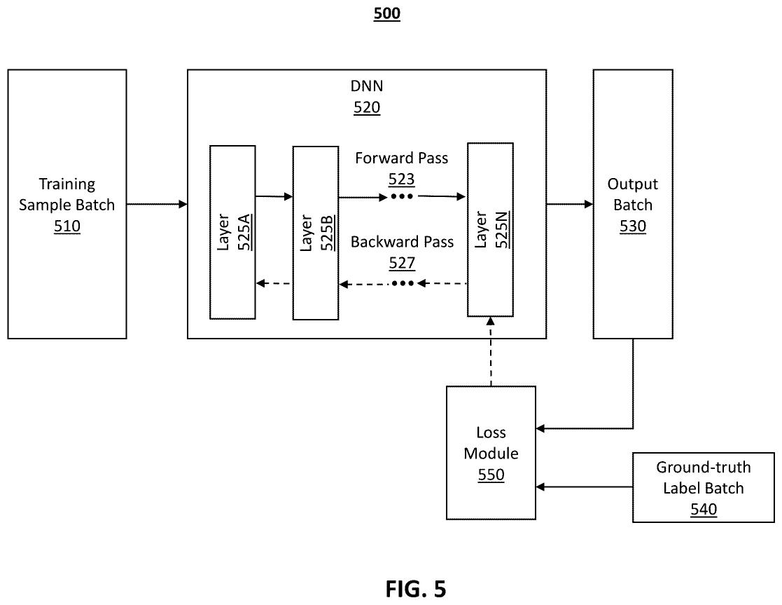

The DNN module 310 generates DNNs. In some embodiments, the DNN module 310 can generate compressed DNNs. The DNN module 310 can define the layered architecture of a DNN. The DNN module 310 can also determine the internal parameters of the DNN through a DNN training process, such as the process 500 in FIG. 5. The DNN module 310 may also determine one or more hyperparameters that defines how the DNN is trained. An example Hyperparameter is a sparsity ratio that defines the sparsity level of one or more deep learning tensors for the DNN. The DNN module 310 may prune parameters used for training or executing the DNN to achieve the sparsity ratio by using a MVUE method. The parameters may be weights, activations, gradients, and so on. In some embodiments, the DNN module 310 can prune a parameter on a tensor-level basis to achieve a N:M structure sparsity. The pruning can reduce the amount of computation resources needed for training or executing the DNN and accelerate the training or execution of the DNN.

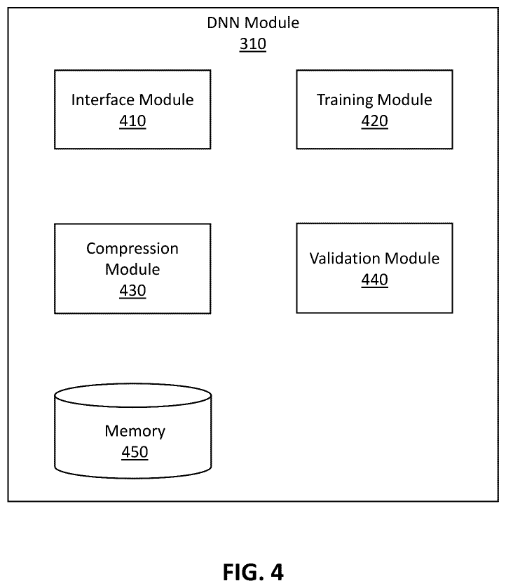

After a DNN is trained or compressed, the DNN module 310 may further validate the DNN before providing the DNN for use in a deep learning application. In some embodiments, the DNN module 310 may compress a DNN based on the computation resources that are available for executing the DNN, such as computation resources available in an edge device. Certain aspects of the DNN module 310 are provided below in conjunction with FIG. 4.

The DNN accelerator 320 executes DNNs provided by the DNN module 310. For instance, the DNN accelerator 320 can perform inference of the DNNs, e.g., by running deep learning operations in the DNNs, for training the DNNs or for using the trained DNNs to solve problems. The DNN accelerator 320 may be at least partially implemented in hardware. As shown in FIG. 3, the DNN accelerator 320 includes a DMA (direct memory access) engine 323 and a compute block 325 that includes a local memory 327 and an MAC array 329. In other embodiments, alternative configurations, different or additional components may be included in the DNN accelerator 320. For instance, the DNN accelerator 320 may include more than one DMA engine 323 or more than one compute block 325. Further, functionality attributed to a component of the DNN accelerator 320 may be accomplished by a different component included in the DNN accelerator 320 or by a different system.

The DMA engine 323 facilitates data transfer between the memory 330 and the local memory 327. The DMA engine 323 may read data from the memory 330 and write data into the local memory 327. The DMA engine 323 may also read data from the local memory 327 and write data into the memory 330. The DMA engine 323 provides a DMA feature that allows the compute block 325 to initiate data transfer between the memory 330 and the local memory 327 and to perform other operations (e.g., operations by the MAC array 329) while the data transfer is in program.

The DMA engine 323 may receive one or more data transfer tasks (e.g., spill in tasks or spill out tasks) for transferring activations of a convolution. A data transfer task of transferring data from the DNN accelerator 320 to the memory 330 may be referred to as a spill out task. A data transfer task of transferring data from the memory 330 to the DNN accelerator 320 may be referred to as a spill in task. After receiving a spill in task, the DMA engine 323 may read data from the memory 330 and write the data into the local memory 327. After receiving a spill out task, the DMA engine 323 may read data from the local memory 327 and write the data into the memory 330. In embodiments where the data is compressed (e.g., the data includes a deep learning tensor that has been compressed by the compression module 430), the DMA engine 323 may read the unpruned values of the deep learning tensor (i.e., non-zero valued values) and disregard the pruned values of the deep learning tensor (i.e., zero valued values) so that the pruned values are not stored in the memory 330 or the local memory 370.

In some embodiments, data transfer tasks may be independent from each other and can be processed by the DMA engine 323 separately. In some embodiments, the DMA engine 323 may process a set of data transfer tasks in accordance with a temporal sequence. For instance, the DMA engine 323 may determine an order in which the data transfer tasks will be processed. The DMA engine 323 may use a first-in-first out (FIFO) method to determine the order. The DMA engine 323 process the first data transfer tasks it received first.

The compute block 325 can perform convolutions or other types of deep learning operations. In some embodiments, the compute block 325 may include one or more processing units, such as include CPU (central processing unit), GPU (graphical processing unit), VPU (versatile processing unit), and XPUs (X processing units), which are heterogeneous computation architectures that can be mapped to CPU, GPU, VPU, other types of processing units, or some combinate thereof. Different processing units may be dynamically selected to run inference, e.g., based on availability of the processing units, etc. In some embodiments, the compute block 325 may complete a deep learning operation through multiple cycles of computation, e.g., in embodiments where the deep learning tensor for the deep learning operation is too large to be processed in a single cycle. The compute block 325 may process a portion of the deep learning tensor in each cycle. In other embodiments, multiple compute blocks may be used to perform a deep learning operation, and each compute block may process a portion of the deep learning tensor.

The compute block 325 may be a tile of the DNN accelerator 320 in embodiments where the DNN accelerator 320 has a tile architecture. The DNN accelerator 320 may include one or more other compute blocks that may operate in parallel with the compute block 325. In some embodiments, the DNN accelerator 320 is a sparsity aware DNN accelerator. The compute block 325 can process sparse data, e.g., sparse data generated by the DNN module 320 through pruning. Additionally or alternatively, the DNN accelerator 320 can process dense data, e.g., data that are not pruned. Certain aspects of the DNN accelerator 320 are provided below in conjunction with FIG. 7.

The compute block 325 includes the local memory 327 and an MAC array 329. The local memory 327 may store data generated by or used by the MAC array 329. The local memory 327 is local to the compute block 325. In the embodiments of FIG. 3, the local memory 327 is inside the compute block 325. In other embodiments, the local memory 327 may be outside the compute block 325. The local memory 327 and the MAC array 329 can be implemented on the same chip. In some embodiments, the local memory 327 includes one or more SRAMs (static random-access memories). The local memory 327 may include one or more buffers, one or more cache memories, one or more register files, or some combination thereof.

The MAC array 329 performs deep learning operations. Example deep learning operations include convolutions (also referred to as “convolutional operations”), pooling operations, elementwise operations, other types of deep learning operations, or some combination thereof. The MAC array 329 includes a plurality of MAC units. The MAC units may be arranged in columns, or columns and rows. In some embodiments, the MAC array 329 receive an input tensor and a weight tensor of a convolution and performs MAC operations with the input tensor and weight tensor. The result of the MAC operations may be an output tensor, which can be further computed, e.g., by the MAC array 329 or another MAC array. The input tensor, weight tensor, and output tensor may be stored in the local memory 327. More details about MAC array are described below in conjunction with FIG. 7.

The memory 330 stores data generated or used by the DNN module 310 and the DNN accelerator 320. The memory 330 may store weights, activations, gradients, or other parameters of DNNs. In some embodiments, the memory 330 stores non-sparse elements of deep learning tensors, i.e., elements having non-zero values, but does not store sparse elements, i.e., elements having zero values. In embodiments where a deep learning tensor of a DNN is pruned, the memory 330 may store one or more sparsity bitmaps for the deep learning tensor. A sparsity bitmap may indicate positions of non-zero valued elements and positions of zero valued elements in the deep learning tensor or in a portion of the deep learning tensor. A sparsity bitmap may include a sequence of bits. Each bit may correspond to an element in the deep learning tensor and have a value of zero or one. A zero valued bit may indicate that the element is zero valued. A one valued bit may indicate that the element is non-zero valued.

The memory 330 may also store other data, such as hyperparameters of DNNs, loss functions for training DNNs, outputs of DNNs, training dataset, and so on. The memory 330 may be outside the compute block 325 or even outside the DNN accelerator 320 and can be referred to as an external memory. In some embodiments, the memory 330 includes one or more DRAMs (dynamic random-access memory). Data stored in the memory 330 (e.g., activations, weights, gradients, etc.) may be transferred to the local memory 317. Also, data generated by the DNN accelerator 320 (e.g., activations, gradients, etc.) may be transferred from the local memory to the memory 330. The data transfer between the DNN accelerator 320 and the memory 330 may be facilitated by the data transfer module 340.

The data transfer module 340 generates data transfer tasks for transferring deep learning tensors between the memory 330 and the DNN accelerator 320. In some embodiments, the data transfer module 340 may generate two types of data transfer tasks: spill in tasks and spill out tasks. The data transfer module 340 may transmit the data transfer tasks to the DMA engine 313, and the DMA engine 313 may perform the data transfer tasks. The data transfer module 340 may provide instructions to the DMA engine 313. In an example, the data transfer module 340 may transmit a “Spill In” descriptor to the DMA engine 313 for performing a spill in task. The data transfer module 340 may transmit a “Spill Out” descriptor to the DMA engine 313 for performing a spill out task.

### Example DNN Module

FIG. 4 is a block diagram of the DNN module 310, in accordance with various embodiments. The DNN module 310 trains DNNs for various tasks, such as image classification, learning relationships between biological cells (e.g., DNA, proteins, etc.), control behaviors for devices (e.g., robots, machines, etc.), and so on. The DNN module 310 includes an interface module 410, a training module 420, a compression module 430, a validation module 440, and a memory 450. In other embodiments, alternative configurations, different or additional components may be included in the DNN module 310. Further, functionality attributed to a component of the DNN module 310 may be accomplished by a different component included in the DNN module 310 or a different system. For instance, the memory 450 may be a part of the memory 330 in FIG. 3. The DNN module 310 or a component of the DNN module 310 may implemented in the computing device 1400.

The interface module 410 facilitates communications of the DNN module 310 with other modules or systems. For example, the interface module 410 establishes communications between the DNN module 310 with an external database to receive data that can be used to train DNNs or input into DNNs to perform tasks. As another example, the interface module 410 supports the DNN module 310 to distribute DNNs to other systems, e.g., computing devices configured to apply DNNs to perform tasks.

The training module 420 trains DNNs by using a training dataset. The training module 420 forms the training dataset. In an embodiment where the training module 420 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validation module 440 to validate performance of a trained DNN. The portion of the training dataset not including the tuning subset and the validation subset may be used to train the DNN.

The training module 420 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 4, 40, 500, 400, or even larger.

The training module 420 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between 2 convolution layers. A fully connected layer involves weights, biases, and neurons. It connects neurons in one layer to neurons in another layer. It is used to classify images between different category by training.

In the process of defining the architecture of the DNN, the training module 420 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 420 defines the architecture of the DNN, the training module 420 inputs a training dataset into the DNN. The training dataset includes a plurality of training samples. An example of a training sample includes an object in an image and a ground-truth label of the object. The training module 420 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 420 uses a cost function to minimize the error.

The training module 420 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 420 finishes the predetermined number of epochs, the training module 420 may stop updating the parameters in the DNN. The DNN having the updated parameters is referred to as a trained DNN.

The compression module 430 compresses DNNs by pruning deep learning tensors for deep learning operations in the DNNs. The process of training or executing a DNN can be accelerated by the pruning. A deep learning tenor may include a plurality of elements that are arranged in a vector, a 2D matrix, a 3D matrix, etc. The elements may be weights, activations, neural gradients, or other parameters of the DNN. In some embodiments, the compression module 430 determines a tensor-level pruning criterion for pruning a deep learning tensor.

The compression module 430 may determine an unbiased estimator for the deep learning tensor. The compression module 430 may use the unbiased estimator and N:M fine-grained sparsity to select which element(s) to prune. The unbiased estimator may be a minimum variance unbiased estimator that can reduce a mean square error:

$$\\ MSE [ θ ( a ) ] = E {‖ θ ( a ) - a ‖}^{2} = E {‖ θ ( a ) - E θ ( a ) ‖}^{2} + {‖ E θ ( a ) - a ‖}^{2} {=}^{△} Var [ θ ( a ) ] + {Bias}^{{}_{} 2} [ θ ( a ) ] ,$$

where α denotes a deterministic vector, θ denotes a random pruning operator, MSE denotes the mean square error, E denotes an expectation over the randoms of θ(α). With the unbiased estimator, Bias² [θ(α)]=0. The compression module 430 may minimize the variance Var[θ(α)].

In some embodiments, the compression module 430 extracts a vector from the deep learning tensor. The compression module 430 may determine a sparsity ratio for the deep learning tensor. The sparsity ratio may be a ratio of the number of pruned elements to the total number of elements in the deep learning tensor. The sparsity ratio may be represented by two pruning parameters: a first pruning parameter that indicates the number of elements to be pruned from a vector and a second pruning parameter that indicates the size of the vector (i.e., the number of elements in the vector). Examples of the sparsity ratio include 1:2, 2:4, 1:4, 2:6, 3:6, 4:6, and so on.

The compression module 430 may determine a pruning probability for each element in an individual vector α that has elements αᵢ, where i represents the index of each element in the vector α. The pruning probability may be denoted by:

$$\\ {p}_{i} = \frac{\vert {a}_{i} \vert}{{\sum }_{i} \vert {a}_{i} \vert}$$

For a vector having a size of two,

$$\\ {p}_{i} = \frac{\vert {a}_{i} \vert}{\vert {a}_{1} \vert + \vert {a}_{2} \vert} .$$

for a vector having a size of four,

$$\\ {p}_{i} = \frac{\vert {a}_{i} \vert}{\vert {a}_{1} \vert + \vert {a}_{2} \vert + \vert {a}_{3} \vert + \vert {a}_{4} \vert} .$$

The compression module 430 may select one or more elements to prune from the vector based on the pruning probabilities of the elements in the vector and a reference probability. The reference probability may be predetermined.

In an example where the compression module 430 uses the unbiased estimator with minimum variance for 1:2 sparsity to prune the deep learning tensor, the compression module 430 extracts one or more vectors from of the tensor. Each vector has the size of 2, and the compression module 430 prunes one element for each vector. A vector having the size of 2 can be denoted as α≙[α₁, α₂], where α₁ and α₂ are the two elements.

The random pruning operator can be denoted as:

$$\\ θ ( a ) = \{ \begin{matrix}[ {v}_{1} , 0 ] , w \cdot p \cdot p \\ [ {v}_{2} , 0 ] , w \cdot p \cdot 1 - p\end{matrix}$$

Where p represents a probability that the first element α₁ would be pruned and can be denoted as

$$\\ p = \frac{\vert {a}_{1} \vert}{\vert {a}_{1} \vert + \vert {a}_{2} \vert} ,$$

and 1−p represents a probability that the second element α₂ would be pruned, v₁ would be the new value of the first element α₁, e.g., in embodiments where the second element α₂ is pruned, to achieve unbiasedness or to minimize biasedness, and v₂ would be the new value of the second element α₂, e.g., in embodiments where the first element α₁ is pruned, to achieve unbiasedness or to minimize biasedness.

The unbiased estimator can be denoted as:

$$\\ E [ θ ( a ) ] = [ {a}_{1} , {a}_{2} ]$$

The total variance of the block can be denoted as:

$$\\ Var [ θ ( a ) ] {=}^{△} {\sum }_{i} Var [ {θ}_{i} ( a ) ] = {\sum }_{i} ( E [ {θ}_{i}^{{}_{} 2} ( a ) ] - ( {E [ {θ}_{i} ( a ) ]}^{2} ) = {v}_{1}^{{}_{} 2} p - {a}_{1}^{{}_{} 2} + {v}_{2}^{{}_{} 2} ( 1 - p ) - {a}_{2}^{{}_{} 2}$$

The total variance of the vector as a function of v₁ alone can be denoted as:

$$\\ {Var}_{B} ( θ ( a ) ) = {v}_{1} \cdot {a}_{1} - {a}_{1}^{{}_{} 2} + \frac{{a}_{2}^{{}_{} 2} \cdot {v}_{1}}{{v}_{1} - {a}_{1}} - {a}_{2}^{{}_{} 2}$$

To minimize the total variance Var_{B} (θ(α)), the equation of Var_{B} (θ(α)) can be differentiated with respect to v₁, and equal to zero to obtain the following random pruning operator θ(α):

$$θ ( a ) = \{ \begin{matrix}[ sign ( {a}_{1} ) \cdot ( \vert {a}_{1} \vert + \vert {a}_{2} \vert ) , 0 ] , w . p . \frac{\vert {a}_{1} \vert}{\vert {a}_{1} \vert + \vert {a}_{2} \vert} \\ [ 0 , sign ( {a}_{2} ) \cdot ( \vert {a}_{1} \vert + \vert {a}_{2} \vert ) ] , w . p . \frac{\vert {a}_{2} \vert}{\vert {a}_{1} \vert + \vert {a}_{2} \vert}\end{matrix}$$

The random pruning operator θ(α) may have the lowest variance of all unbiased estimators. The compression module may use the random pruning operator θ(α) to determine which element to prune. By substituting the lowest variance into the equation of Var_{B} (θ(α)), the optical estimator has a variance of 2α₁α₂. Since the method is unbiased, MSE=Bias²+Var=0+2α₁α₂.

In an example where the compression module 430 uses the unbiased estimator with minimum variance for 2:4 sparsity to prune the deep learning tensor, the compression module 430 extracts one or more vectors from of the tensor. Each vector has the size of 4, and the compression module 430 prunes two elements for each vector. A vector having the size of 4 can be denoted as α≙[α₁, α₂, α₃, α₄], where α₁, α₂, α₃, and α₄ are the four elements. The random pruning operator θ(α) can be denoted as

$${θ}_{i} ( a ) = \frac{{a}_{i}}{{p}_{i}}$$

with probability pᵢ, where denotes i the index of the elements in the vector and has the value of 1, 2, 3, or 4. The unbiased estimate would be:

$$E [ {θ}_{i} ( a ) ] = \frac{{a}_{i}}{{p}_{i}} \cdot {p}_{i} + 0 \cdot ( 1 - {p}_{i} ) = {a}_{i} , {∀}_{i} ∈ \{ 1 , 2 , 3 , 4 \}$$

The variance of each element in the vector is:

$$Var [ {θ}_{i} ( a ) ] = E [ {θ}_{i}^{2} ( a ) ] - {E [ {θ}_{i} ( a ) ]}^{2} = {( \frac{{a}_{i}}{{p}_{i}} )}^{2} \cdot {p}_{i} + {0}^{2} \cdot ( 1 - {p}_{i} ) - {a}_{i}^{2} = \frac{{a}_{i}^{2}}{{p}_{i}} - {a}_{i}^{2}$$

Thus, the total variance in the vector is:

$${Var}_{B} ( θ ( a ) ) {=}^{△} {\sum }_{i} Var [ {θ}_{i} ( a ) ] = {\sum }_{i} ( \frac{{a}_{i}^{2}}{{p}_{i}} - {a}_{i}^{2} )$$

The total variance would be minimized under equality and inequality constraints that can be denoted by:

$${\sum }_{i} {p}_{i} - 2 = 0 ; {p}_{i} - 1 \leq 0 , {∀}_{i} ∈ \{ 1 , 2 , 3 , 4 \}$$

To find pᵢ, the compression module 430 may apply the KKT (Karush-Kuhn-Tucker) conditions on a Langrangian that can be denoted as:

$$L = {\sum }_{j} ( \frac{{a}_{j}^{2}}{{p}_{j}} - {a}_{j}^{2} ) + {\sum }_{j} {λ}_{j} ( {p}_{j} - 1 ) + μ {\sum }_{j} ( {p}_{j} - 2 )$$

Differentiating the Langrangian with respect to pⱼ:

$$\frac{\partial L}{\partial {p}_{i}} = - \frac{{a}_{j}^{2}}{{p}_{i}^{2}} + {λ}_{i} + μ = 0 , {∀}_{i} ∈ \{ 1 , 2 , 3 , 4 \}$$

Where for each i, the constant λᵢ could be zero or positve.

When

$${λ}_{i} = 0 , {p}_{i} = \frac{{a}_{i}}{\sqrt{μ}} .$$

Coupled with the normalization constraint (Σᵢ pᵢ=2) implies that:

$${p}_{i} = \frac{2 {a}_{i}}{{Σ}_{j} {a}_{j}} , {∀}_{i} ∈ \{ 1 , 2 , 3 , 4 \}$$

Tuning to the case where λᵢ>0 for some specific i, we have pᵢ=1 because of the complementary slackness condition in KKT. The normalization constraint (Σᵢ o₁pᵢ=2) therefore guarantees that Σ_{k≠i}pₖ=1, the optimality criterion can be:

$$∃ i : {p}_{i} = 1 and {p}_{k} = \frac{{a}_{k}}{{Σ}_{k \neq i} {a}_{i}} , {∀}_{k} \neq i$$

In an embodiment, given a vector having the size of 4, the compression module 430 may divide the four-element vector to two vectors, each having the size of two, and prune the two vectors with the 1:2 sparsity method described above. In another embodiment, the compression module 430 may prune the vector with one of the two 2:4 sparsity methods described above (i.e., the 2:4 sparsity method for λᵢ=0 and the 2:4 sparsity method for λᵢ>0). In some embodiments, the variance for the 2:4 sparsity ratio (Var[θ_{2:4}(α)]) may be equal to or less than the variance for the 1:2 sparsity ratio (Var[θ_{1:2}([α₁, α₂)]+Var[θ_{1:2}([α₃, α₄)]). In yet another embodiment, the compression module 430 may use a different 2:4 sparsity method, which may be referred to as an approximated MVUE method or approx-MVUE method.

The approx-MVUE method may include two rounds of selection. In the first round, an element αᵢ is selected based on a pruning probability pᵢ:

$${p}_{i} = \frac{\vert {a}_{i} \vert}{\vert {a}_{1} \vert + \vert {a}_{2} \vert + \vert {a}_{3} \vert + \vert {a}_{4} \vert}$$

The pruning probability for each of the four elements α₁, α₂, α₃, and α₄ may be determined to select one of the four elements. After the element is selected, new pruning probabilities of the other three elements can be determined:

$${p}_{j} = \frac{\vert {a}_{j} \vert}{\vert {a}_{1} \vert + \vert {a}_{2} \vert + \vert {a}_{3} \vert + \vert {a}_{4} \vert - \vert {a}_{i} \vert}$$

In the second round, another element can be selected from these three elements based on the new pruning probabilities. The compression module 430 may prune the two unselected elements. The compression module 430 may further change the values of the selected elements to achieve unbiasedness or to minimize biasedness. For instance, for each of the selected elements, the compression module 430 may divide the absolute value of the selected element by the pruning probability and use the result of the division as the new absolute value of the selected element. For the element that was selected in the first round, the compression module 430 may use the pruning probability pᵢ. For the element that was selected in the second round, the compression module 430 may use the pruning probability pⱼ. The compression module 430 may use the original sign of each selected element as the sign of the updated value.

In some embodiments (e.g., embodiments where the deep learning tensor is too large to be processed by a single compute block in a single cycle), the compression module 430 may extract one or more matrices from the deep learning tensor. For instance, the deep learning tensor may be divided into subtensors, which may be processed by different compute blocks or by the same compute block in different cycles. The compression module 430 may extract a vector from each subtensor and combine the vectors into a matrix. In some embodiments, a vector may be a row in the matrix. The compression module 430 may use the MVUE method described above to prune one or more columns in the matrix.

In an example, the size of the deep learning tensor may be 256×256 and the deep learning tensor is to be processed by a compute block that can process a 256×32 tensor in each cycle, the deep learning tensor is therefore to be processed in eight cycles. The compression module may extract one or more matrices from the deep learning tensor. An example matrix may be X:

$$X = [ \begin{matrix}{x}_{0}^{0} & … & {x}_{0}^{255} \\ ⋮ & ⋱ & ⋮ \\ {x}_{7}^{0} & … & {x}_{7}^{255}\end{matrix} ]$$

The compression module may use the MVUE method to prune one or more columns xᵢ in the matrix X, where i=0, 1, 2, . . . 255. The compression module may apply a random pruning operator θ(xᵢ) independently for each column in the matrix X. The random pruning operator θ(xᵢ) may be denoted by:

$$θ ( {x}_{i} ) = \{ \begin{matrix}\frac{{x}_{i}}{{p}_{i}} , w . p . {p}_{i} \\ 0 , w . p . ( 1 - {p}_{i} )\end{matrix}$$

It is unbiased since:

$$E [ θ ( {x}_{i} ) ] = {p}_{i} \cdot [ \begin{matrix}{x}_{0}^{i} / {p}_{i} \\ ⋮ \\ {x}_{7}^{i} / {p}_{i}\end{matrix} ] + ( 1 - {p}_{i} ) [ \begin{matrix}0 \\ ⋮ \\ 0\end{matrix} ] = [ \begin{matrix}{x}_{0}^{i} \\ ⋮ \\ {x}_{7}^{i}\end{matrix} ] = {x}_{i}$$

To find an unbiased pruning that minimizes the variance, the variance of each column xᵢ (i.e., Var[θ(xᵢ)]) can be calculated:

$$Var [ θ ( {x}_{i} ) ] = {\sum }_{j}^{7} E [ {θ}^{2} ( {x}_{j}^{i} ) ] - {E}^{2} [ θ ( {x}_{j}^{i} ) ] = {\sum }_{j}^{7} {( \frac{{x}_{j}^{i}}{{p}_{i}^{2}} )}^{2} \cdot {p}_{i} - {( {x}_{j}^{i} )}^{2} = {\sum }_{j}^{7} \frac{{( {x}_{j}^{i} )}^{2}}{{p}_{i}} - {( {x}_{j}^{i} )}^{2}$$

where j denotes the row index of an element. Thus, the total variance for all columns in the matrix (i.e., Var[θ(X)]) would be:

$$Var [ θ ( X ) ] = {\sum }_{i = 0}^{255} {\sum }_{j = 0}^{7} \frac{{( {x}_{j}^{i} )}^{2}}{{p}_{i}} - {( {x}_{j}^{i} )}^{2}$$

Since the probabilities {pᵢ} sum up to 1, p₀=1−Σᵢ₌₁²⁵⁵pᵢ, and the total variances Var[θ(X)] can become:

$$Var [ θ ( X ) ] = {\sum }_{i = 0}^{255} {\sum }_{j = 0}^{7} \frac{{( {x}_{j}^{i} )}^{2}}{{p}_{i}} - {( {x}_{j}^{i} )}^{2} = Var [ θ ( X ) ] = [ {\sum }_{i = 0}^{255} {\sum }_{j = 0}^{7} \frac{{( {x}_{j}^{i} )}^{2}}{{p}_{i}} - {( {x}_{j}^{i} )}^{2} ] + \frac{{( {x}_{j}^{0} )}^{2}}{{p}_{0}} - {( {x}_{j}^{0} )}^{2} = [ {\sum }_{i = 0}^{255} {\sum }_{j = 0}^{7} \frac{{( {x}_{j}^{i} )}^{2}}{{p}_{i}} - {( {x}_{j}^{i} )}^{2} ] + \frac{{( {x}_{j}^{0} )}^{2}}{1 - {\sum }_{i = 1}^{255} {p}_{i}} - {( {x}_{j}^{0} )}^{2}$$

Taking the derivative of Var[θ(X)] with respect to pᵢ and setting it to zero:

$$\frac{\partial Var [ θ ( X ) ]}{\partial {p}_{i}} = - {\sum }_{j}^{7} \frac{{( {x}_{j}^{i} )}^{2}}{{p}_{i}^{2}} + \frac{{( {x}_{j}^{0} )}^{2}}{{( 1 - {Σ}_{i = 1}^{255} {p}_{i} )}^{2}} = 0$$

which is equivalent to:

$${\sum }_{j}^{7} \frac{{( {x}_{j}^{i} )}^{2}}{{p}_{i}^{2}} = \frac{{( {x}_{j}^{0} )}^{2}}{{( 1 - {Σ}_{i = 1}^{255} {p}_{i} )}^{2}}$$

$$\frac{{( {x}_{j}^{0} )}^{2}}{{( 1 - {Σ}_{i = 1}^{255} {p}_{i} )}^{2}}$$

can be denoted as C₀, so:

$${\sum }_{j}^{7} \frac{{( {x}_{j}^{i} )}^{2}}{{p}_{i}^{2}} = {C}_{0}$$

$${\sum }_{j}^{7} {( {x}_{j}^{i} )}^{2} = {C}_{0} \cdot {p}_{i}^{2}$$

$$\sqrt{{\sum }_{j}^{7} {( {x}_{j}^{i} )}^{2} = \sqrt{{C}_{0}} \cdot {p}_{i}}$$

Since the square root of the sum of the squares of the elements in a column xᵢ is its Euclidean norm ∥xᵢ∥, i.e., ∥xᵢ∥₂=\sqrt{Σⱼ⁷(xⱼⁱ)²}, the optimal solution can be denoted by:

$${‖ {x}_{i} ‖}_{2} = \sqrt{{C}_{0}} \cdot {p}_{i}$$

For any two columns xₘ and ₓn in the matrix X, the optimality criterion for zeroing these columns is:

$${p}_{m} : {p}_{n} = {‖ {x}_{n} ‖}_{2} : {‖ {x}_{m} ‖}_{2}$$

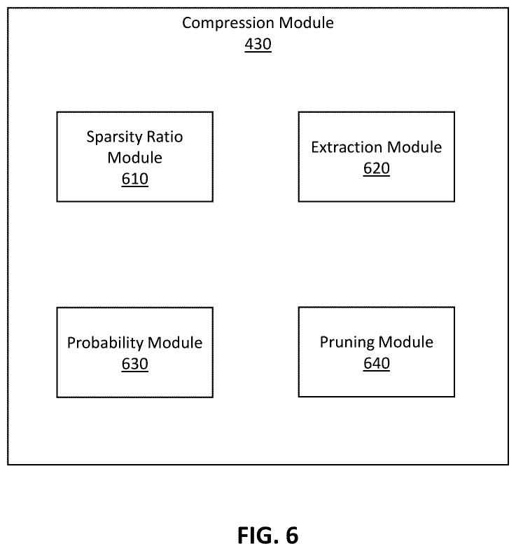

Optimality dictates that the ratio between column norms can be proportional to the probability that they will remain non-zero after pruning. The compression module 430 may select one or more columns to prune based on the pruning probabilities of the columns and a reference probability. Certain aspects of the compression module 430 are provided below in conjunction with FIG. 6.

The validation module 440 verifies accuracy of trained or compressed DNNs. In some embodiments, the validation module 440 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 440 may determine an accuracy score measuring the precision, recall, or a combination of precision and recall of the DNN. The validation module 440 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 440 may compare the accuracy score with a threshold score. In an example where the validation module 440 determines that the accuracy score of the augmented model is less than the threshold score, the validation module 440 instructs the training module 420 to re-train the DNN. In one embodiment, the training module 420 may iteratively re-train the DNN until the occurrence of a stopping condition, such as the accuracy measurement indication that the DNN may be sufficiently accurate, or a number of training rounds having taken place.

The memory 450 stores data received, generated, used, or otherwise associated with the DNN module 310. For example, the memory 450 stores the datasets used by the training module 420 and validation module 440. The memory 450 may also store data generated by the training module 420 and validation module 440, such as the hyperparameters for training DNNs, internal parameters of trained DNNs (e.g., values of tunable parameters of activation functions, such as Fractional Adaptive Linear Units (FALUs)), etc. In the embodiment of FIG. 4, the memory 450 is a component of the DNN module 310. In other embodiments, the memory 450 may be external to the DNN module 310 and communicate with the DNN module 310 through a network.

### Example DNN Training Process

FIG. 5 illustrates an example process 500 of training an DNN 520, in accordance with various embodiments. The process 500 may be performed at least partially by the training module 420 in FIG. 4. The DNN 520 includes a plurality of layers 525A-525N (collectively referred to as “layers 525” or “layer 525”). An example of the DNN 520 is the DNN 100 in FIG. 1. In the embodiments of FIG. 5, the process 500 includes one or more training cycles. Each training cycle may include three stages: inference, backpropagation, and update. In other embodiments, a training cycle may include more, fewer, or different stages.

In the inference stage of a training cycle, a batch of training samples (i.e., training sample batch 510) is input into the DNN 520. The training sample batch 510 includes some or all of the training samples in a training dataset for training the DNN 520. Each training sample in the training sample batch 510 may pass through the layers 525 sequentially, e.g., along the forward pass 523. In each layer 525, one or more deep learning operations may be performed the internal parameters (e.g., weights) of the layer 525. The output from the last layer 525 may be the output of the DNN 520. The training sample batch 510 provides an output batch 530. The output batch 530 may include a plurality of outputs, each of which is generated based on a respective training sample in the training sample batch 510. The inference stage may be performed by a DNN accelerator, e.g., the DNN accelerator 320 in FIG. 3.

In the backpropagation stage, gradients with respect to one or more internal parameters of the DNN 520 are computed. In some embodiments, a gradient tensor including a plurality of gradients with respect to weight is computed based on a backpropagation algorithm. The gradient tensor may have the same spatial size as the corresponding weight tensor (e.g., a kernel). A gradient may be denoted by:

$$\frac{\partial C}{\partial w} = {a}_{i n} {δ}_{out}$$

where

$$\frac{\partial C}{\partial w}$$

is the gradient, din denotes the activation of the neural input to the weight w, and δₒᵤₜ out denotes the error of the neuron output from the weight w.

In some embodiments, the loss module 550 may compute the gradients of a loss function with respect to the weights of the DNN 520 for a single output of the DNN 520. For instance, the loss module 550 may receive the output batch 530 and a ground-truth label batch 540. The ground-truth label batch 540 includes ground-truth labels of the training samples in the training sample batch 510. A training sample may have one or more ground-truth labels. The loss module 550 can determine differences between the outputs and ground-truth labels. For instance, the loss module 550 may determine a different between each output and the corresponding ground-truth label. The loss module 550 may determine a loss by aggregating the differences. The loss module 550 may further determine the gradients based on the loss. In some embodiments, gradients for some or all of the layers 525 are computed sequentially in a backward matter in the backpropagation stage, e.g., along the backward pass 527. For instance, the gradients for a layer (e.g., the layer 525B) is computed before the gradients for a preceding layer (e.g., the layer 525A).

In the update stage, the internal parameters of the DNN 520, such as weights, are updated based on the gradients to reduce or minimize the loss. In some embodiments, the weights are updated once for one training sample batch, such as the training sample batch 510. As there can be multiple training sample batches, the weights can be updated multiple times based on one training dataset. The entire training dataset may be passed through the DNN 520 multiple times, e.g., each batch or training sample may be fed into the DNN 520 multiple times, i.e., multiple epochs.

### Example Compression Module

FIG. 6 is a block diagram of a compression module 430, in accordance with various embodiments. As described above, the compression module 430 can use a MVUE method to prune deep learning tensors, such as gradient tensors, activation tensors, weight tensors, and so on. The compression module 430 can therefore accelerate the training or execution of DNNs. In the embodiments of FIG. 6, the compression module 430 includes a sparsity ratio module 610, an extraction module 620, a probability module 630, and a pruning module 640. In other embodiments, alternative configurations, different or additional components may be included in the compression module 430. Further, functionality attributed to a component of the compression module 430 may be accomplished by a different component included in the compression module 430 or by a different module or system.

The sparsity ratio module 610 determines tensor-level sparsity ratios. For instance, the sparsity ratio module 610 determine a sparsity ratio for a deep learning tensor, such as a gradient tensor, a weight tensor, or an activation tensor. The sparsity ratio may indicate a structured sparsity of the deep learning tensor after the deep learning tensor is pruned by the compression module 430. The sparsity ratio may be a ratio of the number of to-be-pruned elements to the total number of elements in the deep learning tensor. The sparsity ratio may include two pruning parameters to be used for pruning the deep learning tensor and may equal a ratio of the two pruning parameters. The sparsity ratio may have a format of N:M, where N is the first pruning parameter and M is the second pruning parameter. The first pruning parameter may define the number of elements to be pruned for a vector in the deep learning tensor. The second pruning parameter may define the size of the vector. The vector is a portion of the deep learning tensor, i.e., includes a subset of the values in the deep learning tensor. The vector may include two or more values. In some embodiments, N is equal to one or a greater integer, and M is equal to two or a greater integer. M is greater than N.

The extraction module 620 extracts elements from a deep learning tensor based on the sparsity ratio of the deep learning tensor. The extraction module 620 may extract the elements based on the second pruning parameter in the sparsity ratio. For instance, the extraction module 620 may extract M elements from the deep learning tensor in each extraction operation. The M elements may constitute a unit tensor (e.g., a vector or matrix) from which one or more elements are selected and pruned by the pruning module 640. In some embodiments, the extraction module 620 extracts one or more vectors from the deep learning tensor based on the second pruning parameter in the sparsity ratio. Each vector may have a size of the second pruning parameter, i.e., the number of elements in the vector equals the second pruning parameter. For instance, the extraction module 620 extracts one or more vectors having the size of M from every row or column of the deep learning tensor. A spatial size (e.g., height, width, or length) of the deep learning tensor may be a multiple of M.

In other embodiments, the extraction module 620 extracts one or more matrices from the deep learning tensor based on the second pruning parameter in the sparsity ratio. Each matrix may have a width equal the second pruning parameter, i.e., the number of columns in the matrix equals the second pruning parameter. The number of rows in the matrix may vary. In some embodiments, the number of rows in the matrix may equal the number of cycles for an operation performed by a compute block to process the deep learning tensor. Alternatively, the number of rows in the matrix may equal the number of compute blocks used to process the deep learning tensor.

The probability module 630 determines pruning probabilities for vectors or matrices generated by the extraction module 620. The probability module 630 may use an unbiased minimum variance optimality criterion to determine the pruning probabilities. In some embodiments (e.g., embodiments where a vector is extracted from a deep learning tensor by the extraction module 620), the probability module 630 determines element-level pruning probabilities. Each pruning probability corresponds to a respective element. The probability module 630 may determine the pruning probabilities based on values of the elements in the vector. In an example, the probability module 630 determines a pruning probability for an element by dividing the absolute value of the element with the total absolute value of the vector. The sum of the pruning probabilities of the vector may equal one.

In other embodiments (e.g., embodiments where a matrix is extracted from a deep learning tensor by the extraction module 620), the probability module 630 determines column-level pruning probabilities based on norms of the columns in the matrix. In an example, the probability module 630 determines a pruning probability for a column by dividing the Euclidean norm of the column with the total Euclidean norm of the matrix. The Euclidean norm of the column equals the square root of the sum of the squares of all the elements in the column. The sum of the pruning probabilities of the matrix may equal one.

The probability module 630 may also obtain a reference probability. The reference probability may be determined by the probability module 630 or received by the probability module 630, e.g., from a user of the DNN system 300. The reference probability may have a value between zero and one. In some embodiments, the probability module 630 may obtain a tensor-level reference probability, which will be used to prune all the vectors or matrices extracted from the deep learning tensor. In other embodiments, the probability module 630 may obtain different reference probabilities for different vectors or matrices extracted from a deep learning tensor.

The pruning module 640 determines which element(s) to prune and changes the value(s) of the element(s) to zero. In some embodiments (e.g., embodiments where the extraction module vectors from a deep learning vector), the pruning module 640 selects one or more individual elements from each vector based on the first pruning parameter of the sparsity ratio determined by the sparsity ratio module 610. The first pruning parameter may equal the number of the element(s) selected by the pruning module 640. The pruning module 640 may compare at least one of the pruning probabilities of the vector with the reference probability and select the element(s) based on the comparison. A selected element would remain as dense data in the deep learning tensor, while an unselected element would be changed to sparse data in the deep learning tensor. The pruning module 640 sets value(s) of unselected element(s) to zero. The pruning module 640 may change the value(s) of the selected element(s), e.g., increase the absolute value(s) of the selected element(s), to achieve unbiasedness or to minimize biasedness. For instance, the pruning module 640 may increase an absolute value of a selected element by dividing the absolute value with the pruning probability of the selected element. The sign (e.g., positive or negative sign) of the element would remain the same.

In embodiments where the sparsity ratio is 1:2, the pruning module 640 may select one element from a vector including two elements by comparing at least one of the two pruning probabilities with the reference probability. In embodiments where the sparsity ratio is 2:4, the pruning module 640 may convert the pruning process to two pruning processes with a sparsity ratio of 1:2. For instance, the pruning module 640 divides a vector including four elements into two vectors, each of which includes two elements. In an embodiment, the pruning module 640 may divide the four-element vector based on the absolute values of the elements. For instance, the pruning module 640 divides the four-element vector into a vector including the two elements having the highest absolute value and the lowest absolute value and another vector including the other two elements. Then the pruning module 640 selects one element from each of the two-element vectors, ending with two selected elements for the four-element vector so the 2:4 sparsity ratio is met. In another embodiment, the pruning module 640 may select one element from the four-element vector based on the pruning probabilities of the four elements and the reference probability. Then the pruning module may select another element from the other three elements (i.e., excluding the selected element from the vector) of the vector based on the pruning probabilities of the other three elements and the reference probability.

In some embodiments, the pruning module 640 may determine two or more ranges based on one or more pruning probabilities of the vector. Each range may correspond to a respective element in the vector. The pruning module 640 may further determine which range the reference probability falls into. The pruning module 640 may select the element that corresponds to the range that including the reference probability.

In an example where the vector including two elements having pruning probabilities p and 1−p, respectively, the pruning module 640 defines two ranges: a first range of [0, p] and a second range of (p, 1). The first range corresponds to the element having the pruning probability p, and the second range corresponds to the element having the pruning probability 1−p. For a reference probability that is no greater than p (i.e., the reference probability falls into the first range), the pruning module 640 may select the element having the pruning probability p, whose pruning probability is no less than the reference probability. For a reference probability that is greater than p (i.e., the reference probability falls into the second range), the pruning module 640 may select the element having the pruning probability 1−p. The element having the pruning probability p may be arranged before or after the other element in the vector.

In other examples where the vector includes more than two elements (e.g., four elements), the pruning module 640 may define more than two ranges. For instance, the vector α≙[α₁, α₂, α₃, α₄], where α₁, α₂, α₃, and α₄ are four elements having pruning probabilities p₁, p₂, p₃, and p₄, respectively and α₁≤α₂≤α₃≤α₄, the pruning module 640 may define four ranges. The first range is [0, p₁] and corresponds to α₁, the second range is (p₁, p₁+p₂] and corresponds to α₂, the third range is (p₁+p₂, p₁+p₂+p₃] and corresponds to α₃, and the fourth range is (p₁+p₂+p₃, 1] and corresponds to α₄. Each pruning probability may equal the absolute value of the corresponding element divided by the total absolute value of the vector. The pruning module 640 may determine which range includes the reference probability and select the element corresponding to that range.

The pruning module 640 may further select another element from the three unselected elements. In an example where the first element α₁ is selected, the pruning module 640 may determine new pruning probabilities for the three elements α₂, α₃, and α₄. The new pruning probability of an element may equal the absolute value of the element divided by the total absolute value of the three elements α₂, α₃, and α₄. The pruning module 640 may define three ranges: the first range is [0, p₂′] and corresponds to α₂, the second range is (p₂′, p₂′+p₃′] and corresponds to α₃, the third range is (p₂′+p₃′, 1] and corresponds to α₄. The pruning module 640 may select one of the three elements based on which of the three ranges and a new reference probability. For instance, the element corresponding to the range, into which the new reference probability falls, may be selected. The new reference probability may be the same as or different from the reference probability used for all the four elements.

In other embodiments (e.g., embodiments where the extraction module matrices from a deep learning matrix), the pruning module 640 selects one or more individual columns from each matrix based on the first pruning parameter of the sparsity ratio determined by the sparsity ratio module 610. The first pruning parameter may equal the number of the column(s) selected by the pruning module 640. The pruning module 640 may compare at least one of the pruning probabilities of the matrix with the reference probability and select the column(s) based on the comparison. A selected column would remain as dense data in the deep learning tensor, while an unselected column would be changed to sparse data in the deep learning tensor. The pruning module 640 changes value(s) of unselected column(s) to zero. The pruning module 640 may change the value(s) of the selected column(s), e.g., increase the absolute value(s) of the selected column(s), to achieve unbiasedness or to minimize biasedness. For instance, the pruning module 640 may increase an absolute value in a selected column by dividing the absolute value with the pruning probability of the selected column. The sign (e.g., positive or negative sign) of the value would remain the same.

In embodiments where the sparsity ratio is 1:2, the pruning module 640 may select one column from a matrix including two columns by comparing at least one of the two pruning probabilities with the reference probability. In embodiments where the sparsity ratio is 2:4, the pruning module 640 may convert the pruning process to two pruning processes with a sparsity ratio of 1:2. For instance, the pruning module 640 divides a matrix including four columns into two matrices, each of which includes two columns. In an embodiment, the pruning module 640 may divide the four-column matrix based on the absolute values of the columns. For instance, the pruning module 640 divides the four-column matrix into a matrix including the two columns having the highest absolute value and the lowest absolute value and another matrix including the other two columns. Then the pruning module 640 selects one column from each of the two-column matrices, ending with two selected columns for the four-column matrix so the 2:4 sparsity ratio is met. In another embodiment, the pruning module 640 may select one column from the four-column matrix based on the pruning probabilities of the four columns and the reference probability. Then the pruning module may select another column from the other three columns (i.e., excluding the selected column from the matrix) of the matrix based on the pruning probabilities of the other three columns and the reference probability.

In some embodiments, the pruning module 640 may determine two or more ranges based on one or more pruning probabilities of the matrix. Each range may correspond to a respective column in the matrix. The pruning module 640 may further determine which range the reference probability falls into. The pruning module 640 may select the column that corresponds to the range that including the reference probability.

In an example where the matrix including two columns having pruning probabilities p and 1−p, respectively, the pruning module 640 defines two ranges: a first range of [0, p] and a second range of (p, 1). The first range corresponds to the column having the pruning probability p, and the second range corresponds to the column having the pruning probability 1−p. For a reference probability that is no greater than p (i.e., the reference probability falls into the first range), the pruning module 640 may select the column having the pruning probability p, whose pruning probability is no less than the reference probability. For a reference probability that is greater than p (i.e., the reference probability falls into the second range), the pruning module 640 may select the column having the pruning probability 1−p. The column having the pruning probability p may be arranged before or after the other column in the matrix.

In other examples where the matrix includes more than two columns (e.g., four columns), the pruning module 640 may define more than two ranges. For instance, the matrix α≙[α₁, α₂, α₃, α₄], where α₁, α₂, α₃, and α₄ are the norms of four columns having pruning probabilities p₁, p₂, p₃, and p₄, respectively and α₁≤α₂≤α₃≤α₄, the pruning module 640 may define four ranges. The first range is [0, p₁] and corresponds to α₁, the second range is (p₁, p₁+p₂] and corresponds to α₂, the third range is (p₁+p₂, p₁+p₂+p₃] and corresponds to α₃, and the fourth range is (p₁+p₂+p₃, 1] and corresponds to α₄. Each pruning probability may equal the norm of the corresponding column divided by the total norm of the matrix. The pruning module 640 may determine which range includes the reference probability and select the column corresponding to that range.

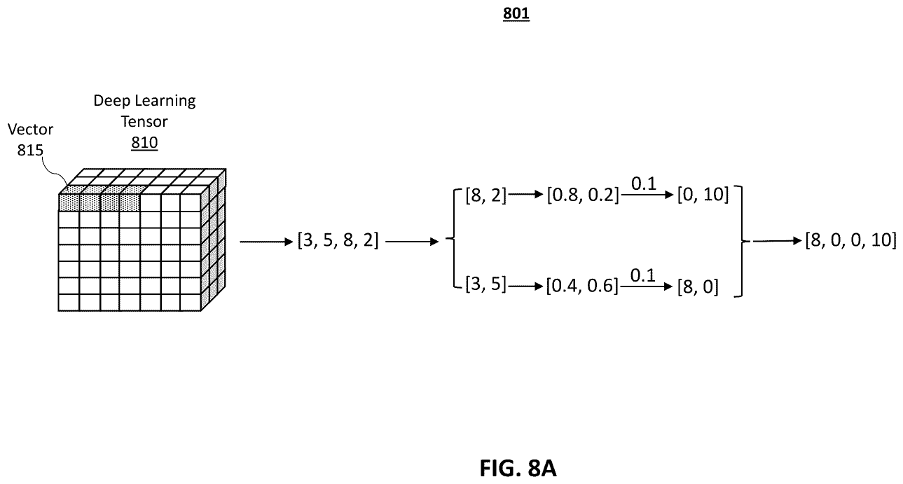

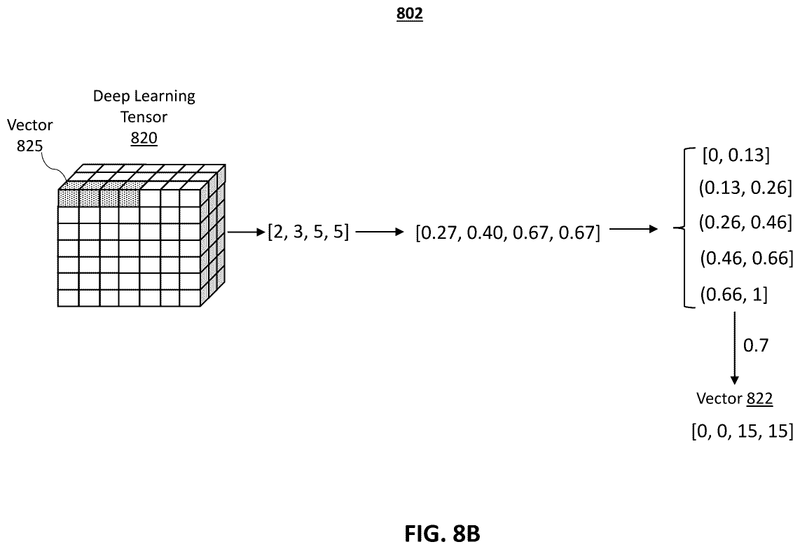

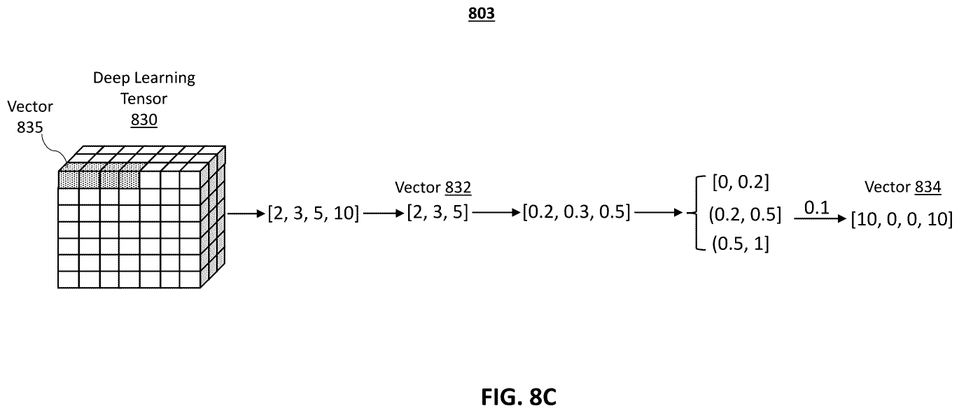

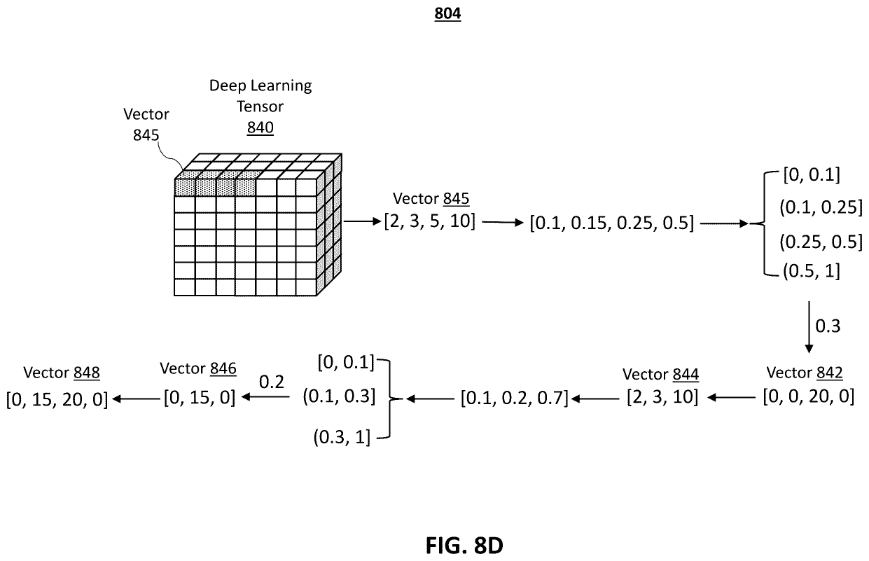

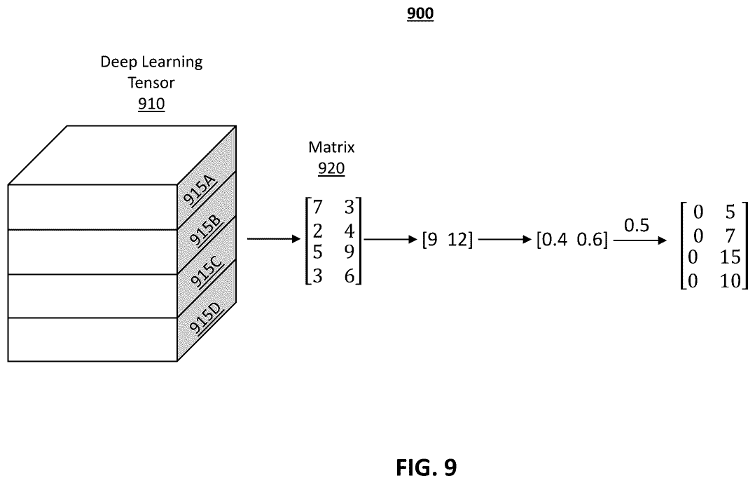

The pruning module 640 may further select another column from the three unselected columns. In an example where the first column α₁ is selected, the pruning module 640 may determine new pruning probabilities for the three columns α₂, α₃, and α₄. The new pruning probability of a column may equal the norm of the column divided by the total norm of the three columns. The pruning module 640 may define three ranges: the first range is [0, p₂′] and corresponds to α₂, the second range is (p₂′, p₂′+p₃′] and corresponds to α₃, the third range is (p₂′+p₃′, 1] and corresponds to α₄. The pruning module 640 may select one of the three columns based on which of the three ranges and a new reference probability. For instance, the column corresponding to the range, into which the new reference probability falls, may be selected. The new reference probability may be the same as or different from the reference probability used for all the four columns. More details regarding pruning deep learning tensors are provided below in conjunction with FIGS. 8A-8D and 9.

### Example MAC Array

FIG. 7 illustrates an example MAC array 700, in accordance with various embodiments. The MAC array 700 is an embodiment of the MAC array 319 in FIG. 3. The MAC array 700 includes a plurality of MAC units 710 (individually referred to as “MAC unit 710”). A MAC unit 710 may be considered as a neuron of the DNN run by the MAC array 700. The MAC units 710 perform MAC operations, such as integer MAC operations, floating-point MAC operations, and so on. The MAC units 710 may also be referred to as neurons or nodes in the DNN. Each MAC unit 710 has 2 input signals 750 and 760 and an output signal 770. The input signal 750 is at least a portion of an input tensor of a convolution. The input signal 760 is at least a portion of a filter of the convolution. In some embodiments, the input signal 750 of a MAC unit 710 includes one or more input operands, and the input signal 760 includes one or more weight operands.

Each MAC unit 710 performs an MAC operation on the input signals 750 and 760 and outputs the output signal 770, which is a result of the MAC operation. Some or all of the input signals 750 and 760 and the output signal 770 may be in an integer format, such as INT8, or floating-point format, such as FP16 or BF16. For purpose of simplicity and illustration, the input signals and output signal of all the MAC units 710 have the same reference numbers, but the MAC units 710 may receive different input signals and output different output signals from each other. Also, a MAC unit 710 may be different from another MAC unit 710, e.g., including more, fewer, or different components. A MAC unit 710 may include one or more multipliers and one or more adders.

As shown in FIG. 7, the MAC units 710 are connected to each other, as indicated by the dash arrows in FIG. 7. The output signal 770 of an MAC unit 710 may be sent to many other MAC units 710 (and possibly back to itself) as input signals via the interconnections between MAC units 710. In some embodiments, the output signal 770 of an MAC unit 710 may incorporate the output signals of one or more other MAC units 710 through an accumulate operation of the MAC unit 710 and generate an internal partial sum of the MAC array. Certain aspects of the MAC units 710 are described below in conjunction with FIG. 5.

In the embodiments of FIG. 7, the MAC units 710 are arranged into columns 705 (individually referred to as “column 705” or “MAC column 705”). The input and weights of the layer may be distributed to the MAC units 710 based on the columns 705. Each column 705 has a column buffer 720. The column buffer 720 stores data provided to the MAC units 710 in the column 705 for a short amount of time. The column buffer 720 may also store data output by the last MAC unit 710 in the column 705. The output of the last MAC unit 710 may be a sum of the MAC operations of all the MAC units 710 in the column 705, which is a column-level internal partial sum of the MAC array 700. In other embodiments, input and weights may be distributed to the MAC units 710 based on rows in the MAC array 700. The MAC array 700 may include row buffers in lieu of column buffers 720. A row buffer may store input signals of the MACs in the corresponding row and may also store a row-level internal partial sum of the MAC array 700.

As shown in FIG. 7, each column buffer 720 is associated with a load 730 and a drain 740. The data provided to the column 705 is transmitted to the column buffer 720 through the load 730, e.g., through upper memory hierarchies, e.g., a memory external to the compute tile. The data generated by the column 705 is extracted from the column buffers 720 through the drain 740. In some embodiments, data extracted from a column buffer 720 is sent to upper memory hierarchies, e.g., a memory external to the compute tile, through the drain operation. In some embodiments, the drain operation does not start until all the MAC units 710 in the column 705 have finished their MAC operations.

### Example Process of Pruning Deep Learning Tensor

FIG. 8A illustrates a process 801 of pruning a deep learning tensor 810 with a 1:2 sparsity method, in accordance with various embodiments. The process 801 may be performed by the compression module 430. The deep learning tensor 810 is a 3D matrix where a plurality of values is arranged. Each value is represented by a cube in FIG. 8A. The values may be weights, activations, gradients, or other types of parameters of a DNN. In embodiments where the deep learning tensor 810 is an activation tensor, the deep learning tensor 810 may be the input tensor 210 or the output tensor 230 in FIG. 2. In embodiments where the deep learning tensor 810 is a weight tensor, the deep learning tensor 810 may be the filter 220 in FIG. 2.

The process 801 is based on a 2:4 sparsity ratio and a MVUE method, in which the 1:2 sparsity method is applied twice to select two of the four elements for pruning. In the process 801, a vector 815 is extracted from the deep learning tensor 810. The vector 815 includes four elements that have values of 3, 5, 8, and 2 respectively. The four elements are arranged in a sequence, which may be determined based on their sequence in the deep learning tensor 810. For purpose of illustration, the vector 815 is located at the top left side of the deep learning tensor 810. In other embodiments, the vector 815 may have a different location in the deep learning tensor 810.

After the vector 815 is generated, the vector 815 are divided into two vectors: a first vector [8,2] and a second vector [3,5]. The first vector includes the two elements having the highest value and the lowest value of the vector 815. The second vector includes the other two elements of the vector 815. Next, a 1:2 structured sparsity pruning is performed on each of the two vectors. For the first vector, two pruning probabilities are determined: the pruning probability of the first element (i.e., element having the value of 8) is 0.8, the pruning probability of the second element (i.e., element having the value of 2) is 0.2.

A reference probability 0.1 is used. As the reference probability is smaller than 0.2 (i.e., the pruning probability of the second element), the first element is selected for pruning and the second element is selected for remaining as dense data. In some embodiments (e.g., the embodiments of FIG. 8A), two ranges may be determined based on the pruning probability of the second element. The two ranges may include a first range from 0 to 0.2 (including 0 and 0.2) and a second range from 0.2 and 1 (excluding 0.2 but including 1). Then it is determined which range the reference probability falls into. As the reference probability falls into the first range, the first element is selected for pruning and the second element is selected for remaining as dense data. The value of the first element is changed to zero. Also, the value of the second element is updated to 10, i.e., 2 divided by 0.2. The sign of the updated value of the second element is the same as the sign of the original value of the second element. Thus, the first vector is modified to [0, 10].

In other embodiments, two ranges may be determined based on the pruning probability of the first element. Thus, the two ranges include a first range from (including 0 and 0.8) and a second range from 0.8 and 1 (excluding 0.8 but including 1). As the reference probability falls into the first range, the second element is selected for pruning and the first element is selected for remaining as dense data. The value of the first element would be changed to 10, i.e., 8 divided by 0.8, and the value of the second element is set to 0.

For the second vector [3, 5], the pruning probabilities are [0.4, 0.6]. With the reference probability being 0.1, the first element is selected for remaining as dense data and the second element is selected for pruning as the reference probability falls into the range from 0 and 0.4. The value of the first element is changed to 8, which equals 3 divided by 0.4. The second vector is modified to [8, 0]. Combing the modified first vector and the modified second vector, the vector 815 is modified to [8, 0, 0, 10]. For the purpose of simplicity, the values in FIG. 8A are numbers with no decimal place, and the probabilities are numbers with one decimal place. In other embodiments, different numbers of decimal places may be used.

The number of dense values (i.e., non-zero values) in the vector 815 is reduced from four to two. Even though FIG. 8A shows the pruning of the vector 815, the process 801 may include pruning of other vectors extracted from the deep learning tensor 810, which may use the 1:2 sparsity method or a different method, such as the methods described below in conjunction with FIGS. 8B-8D. In some embodiments, half of the values in the deep learning tensor 810 can be pruned based on the 2:4 sparsity ratio. As the deep learning tensor 810 becomes smaller, the memory and compute footprints needed for computing the deep learning tensor 810 can be reduced and therefore, the training or execution of the DNN can be accelerated.

FIG. 8B illustrates a process 802 of pruning a deep learning tensor 820 with a 2:4 sparsity method, in accordance with various embodiments. The process 802 is based on a 2:4 sparsity ratio. The 2:4 sparsity method in the embodiments of FIG. 8D may be referred to as an optimal 2:4 sparsity method. The process 802 may be performed by the compression module 430. The deep learning tensor 820 is a 3D matrix where a plurality of values is arranged. Each value is represented by a cube in FIG. 8D. The values may be weights, activations, gradients, or other types of parameters of a DNN. In embodiments where the deep learning tensor 820 is an activation tensor, the deep learning tensor 820 may be the input tensor 210 or the output tensor 230 in FIG. 2. In embodiments where the deep learning tensor 820 is a weight tensor, the deep learning tensor 820 may be the filter 220 in FIG. 2.

In the process 802, a vector 825 is extracted from the deep learning tensor 820. The vector 825 includes four elements that have values of 2, 3, 5, and 5 respectively. The four elements are arranged in a sequence, which may be determined based on their sequence in the deep learning tensor 820. For purpose of illustration, the vector 825 is located at the top left side of the deep learning tensor 820. In other embodiments, the vector 825 may have a different location in the deep learning tensor 820. The vector 825 can be denoted as a ª [α₁, α₂, α₃, α₄], where α₁=2, α₂=3, α₃=5, and α₄=5.

After the vector 825 is generated, pruning probabilities are determined. In a first embodiment (e.g., an embodiment where α₄≤2α₁+α₃), the following pruning probabilities may be determined:

$${p}_{12} = 0$$

$${p}_{13} = \frac{2 {a}_{1} + {a}_{3} - {a}_{4}}{2 ( {a}_{1} + {a}_{2} + {a}_{3} + {a}_{4} )}$$

$${p}_{14} = \frac{2 {a}_{1} - {a}_{3} + {a}_{4}}{2 ( {a}_{1} + {a}_{2} + {a}_{3} + {a}_{4} )}$$

$${p}_{23} = \frac{2 {a}_{2} + {a}_{3} - {a}_{4}}{2 ( {a}_{1} + {a}_{2} + {a}_{3} + {a}_{4} )}$$

$${p}_{24} = \frac{2 {a}_{2} - {a}_{3} + {a}_{4}}{2 ( {a}_{1} + {a}_{2} + {a}_{3} + {a}_{4} )}$$

$${p}_{34} = \frac{- {a}_{1} - {a}_{2} + {a}_{3} + {a}_{4}}{{a}_{1} + {a}_{2} + {a}_{3} + {a}_{4}}$$

These pruning probabilities satisfies the optimality condition described above, e.g., in paragraph 92. Taking the pruning probability p₁ of α₁ and the pruning probability p₂ of α₂ as example:

$$\frac{{p}_{1}}{{p}_{2}} = \frac{{p}_{12} + {p}_{13} + {p}_{14}}{{p}_{12} + {p}_{23} + {p}_{24}} = \frac{{a}_{1}}{{a}_{2}}$$

In a second embodiment (e.g., an embodiment where 2α₁+α₃≤α₄≤α₁+α₂+α₃), the following pruning probabilities may be determined:

$${p}_{12} = 0$$

$${p}_{13} = 0$$

$${p}_{14} = \frac{2 {a}_{1}}{{a}_{1} + {a}_{2} + {a}_{3} + {a}_{4}}$$

$${p}_{23} = \frac{{a}_{1} + {a}_{2} + {a}_{3} - {a}_{4}}{{a}_{1} + {a}_{2} + {a}_{3} + {a}_{4}}$$

$${p}_{24} = \frac{- {a}_{1} + {a}_{2} - {a}_{3} + {a}_{4}}{2 ( {a}_{1} + {a}_{2} + {a}_{3} + {a}_{4} )}$$

$${p}_{34} = \frac{- {a}_{1} - {a}_{2} + {a}_{3} + {a}_{4}}{{a}_{1} + {a}_{2} + {a}_{3} + {a}_{4}}$$

These pruning probabilities satisfies the optimality condition described above, e.g., in paragraph 92. Taking the pruning probability p₁ of α₁ and the pruning probability p₂ of α₂ as example:

$$\frac{{p}_{1}}{{p}_{2}} = \frac{{p}_{12} + {p}_{13} + {p}_{14}}{{p}_{12} + {p}_{23} + {p}_{24}} = \frac{{a}_{1}}{{a}_{2}}$$

The vector 825 is in the first embodiment, as α₄≤2α₁+α₃. Thus, p₁₂=0, p₁₃=0.13, p₁₄=0.13, p₂₃=0.2, p₂₄=0.2, and p₃₄=0.33. These probabilities can define five ranges: [0, 0.13] corresponding to p₁₃, (0.13, 0.26] (where 0.26 is obtained by summing p₁₃ with p₁₄) corresponding to p₁₄, (0.26, 0.46] (where 0.46 is obtained by summing 0.26 with p₂₃) corresponding to p₂₃, (0.46, 0.66] (where 0.66 is obtained by summing 0.46 with p₂₄) corresponding to p₂₄, and (0.66, 1] corresponding to p₃₄. With a reference probability is 0.7, the last range is selected. The last range corresponds to p₃₄, so the third element α₃ and the fourth element α₄ are selected as dense data and their values are rescaled. For instance, each of α₃ and α₄ are divided by p₃₄, which equals 15. The first element α₁ and the second element α₂ are pruned. The vector 825 is changed to a vector 822 that includes 0, 0, 15, and 15.

The number of dense values (i.e., non-zero values) in the vector 825 is reduced from four to two. Even though FIG. 8D shows the pruning of the vector 825, the process 802 may include pruning of other vectors extracted from the deep learning tensor 820, which may use the same 2:4 sparsity method or a different method, such as the methods described below in conjunction with FIGS. 8A, 8C, and 8D. In some embodiments, half of the values in the deep learning tensor 820 can be pruned based on the 2:4 sparsity ratio. As the deep learning tensor 820 becomes smaller, the memory and compute footprints needed for computing the deep learning tensor 820 can be reduced and therefore, the training or execution of the DNN can be accelerated.

FIG. 8C illustrates a process 803 of pruning a deep learning tensor 830 with another 2:4 sparsity method, in accordance with various embodiments. The process 803 is based on a 2:4 sparsity ratio. The 2:4 sparsity method in the embodiments of FIG. 8D may be referred to as an optimal 2:4 sparsity method. The process 804 may be performed by the compression module 430. The deep learning tensor 830 is a 3D matrix where a plurality of values is arranged. Each value is represented by a cube in FIG. 8D. The values may be weights, activations, gradients, or other types of parameters of a DNN. In embodiments where the deep learning tensor 830 is an activation tensor, the deep learning tensor 830 may be the input tensor 210 or the output tensor 230 in FIG. 2. In embodiments where the deep learning tensor 830 is a weight tensor, the deep learning tensor 830 may be the filter 220 in FIG. 2.

In the process 804, a vector 835 is extracted from the deep learning tensor 830. The vector 835 includes four elements that have values of 2, 3, 5, and 10 respectively. The four elements are arranged in a sequence, which may be determined based on their sequence in the deep learning tensor 830. For purpose of illustration, the vector 835 is located at the top left side of the deep learning tensor 830. In other embodiments, the vector 835 may have a different location in the deep learning tensor 830.

After the vector 835 is generated, it is determined that the fourth element 10 is no less than the sum of the other three elements. Thus, the pruning probability of the fourth element is determined to be 1. Also, the fourth element is selected as dense data. Another element is to be selected from the other three elements. The pruning probabilities of the other three elements are determined based on a vector 832 that does not include the fourth element. In the vector 832, the pruning probability of each element is equal to the absolute value of the element divided by the sum of the absolute values of all the three elements. The pruning probabilities of the three elements are 0.2, 0.3, and 0.5, respectively, which provides three ranges: [0, 0.2], (0.2, 0.5], and (0.5, 0.1]. These pruning probabilities meet the satisfies the optimality condition described above, e.g., in paragraph 93.

The reference probability is 0.1, which falls into the first range, so the first element is selected. The value of the first element is changed to its original value (i.e., 2) divided by its pruning probability (i.e., 0.2). Thus, the first element has a new value of 10. The second and third elements are pruned and have new values of 0. The value of the fourth element is not changed since its pruning probability is 1. Thus, a vector 834 that includes four elements with values of 10, 0, 0, and 10, respectively is formed after the pruning process.

The number of dense values (i.e., non-zero values) in the vector 835 is reduced from four to two. Even though FIG. 8C shows the pruning of the vector 835, the process 803 may include pruning of other vectors extracted from the deep learning tensor 830, which may use the same 2:4 sparsity method or a different method, such as the methods described below in conjunction with FIGS. 8A, 8B, and 8D. In some embodiments, half of the values in the deep learning tensor 830 can be pruned based on the 2:4 sparsity ratio. As the deep learning tensor 830 becomes smaller, the memory and compute footprints needed for computing the deep learning tensor 830 can be reduced and therefore, the training or execution of the DNN can be accelerated.

FIG. 8D illustrates a process 804 of pruning a deep learning tensor 840 with yet another 2:4 sparsity method, in accordance with various embodiments. The process 804 is based on a 2:4 sparsity ratio. The 2:4 sparsity method in the embodiments of FIG. 8D may be referred to as an approximated MVUE method or approx-MVUE method. The process 804 may be performed by the compression module 430. The deep learning tensor 840 is a 3D matrix where a plurality of values is arranged. Each value is represented by a cube in FIG. 8D. The values may be weights, activations, gradients, or other types of parameters of a DNN. In embodiments where the deep learning tensor 840 is an activation tensor, the deep learning tensor 840 may be the input tensor 210 or the output tensor 230 in FIG. 2. In embodiments where the deep learning tensor 840 is a weight tensor, the deep learning tensor 840 may be the filter 220 in FIG. 2.

In the process 804, a vector 845 is extracted from the deep learning tensor 840. The vector 845 includes four elements that have values of 2, 3, 5, and 10 respectively. The four elements are arranged in a sequence, which may be determined based on their sequence in the deep learning tensor 840. For purpose of illustration, the vector 845 is located at the top left side of the deep learning tensor 840. In other embodiments, the vector 845 may have a different location in the deep learning tensor 840.

After the vector 845 is generated, pruning probabilities of the four elements are determined. In the embodiments of FIG. 8D, the pruning probability of each element equals the absolute value of the element divided by the total absolute value of the vector 845. The total absolute value of the vector 845 is the sum of the absolute values of the four elements. Accordingly, the first element has a pruning probability of 0.1, the second element has a pruning probability of 0.15, the third element has a pruning probability of 0.25, and the fourth element has a pruning probability of 0.5. Four ranges are determined: the first range is [0, 0.1] (including both 0 and 0.1, where 0.1 is the pruning probability of the first element), the second range is (0.1, 0.25] (excluding 0.1 but including 0.25, where 0.25 is the pruning probability of the second element plus 0.1), a third range is (0.25, 0.5] (excluding 0.25 but including 0.5, where 0.5 is the pruning probability of the third element plus 0.25), and the fourth range is (0.5, 1] (excluding 0.5 but including 1).

One of the four elements is selected based on a first reference probability, e.g., based on the range into which the first reference probability falls. In an embodiment where the first reference probability falls into the first range, the first element may be selected. In an embodiment where the first reference probability falls into the second range, the second element may be selected. In an embodiment where the first reference probability falls into the third range, the third element may be selected. In an embodiment where the first reference probability falls into the fourth range, the fourth element may be selected. In the embodiments of FIG. 8D, the first reference probability is 0.3, falling into the third range. Thus, the third element is selected for remaining as dense data. The value of the third element is updated to the result of dividing the original value of the third element by the pruning probability of the third element. The result of the division is 20. Thus, a vector 842 including values of 0, 0, 20, and 0 is obtained.

Further, another element is selected from the first element, the second element, and the fourth element of the vector 845, which constitute a vector 844. Three pruning probabilities for the vector 844 is determined: 0.1, 0.2, and 0.7. Each pruning probability equals the absolute value of the corresponding element divided by the total absolute value of the vector 844. Three ranges are determined: [0, 0.3], (0.1, 0.3], and (0.3, 1].

One of the three elements is selected based on a second reference probability, e.g., based on the range into which the second reference probability falls. In an embodiment where the first reference probability falls into the first range, the first element may be selected. In an embodiment where the first reference probability falls into the second range, the second element may be selected. In an embodiment where the first reference probability falls into the third range, the third element (which is the fourth element in the vector 845) may be selected. In the embodiments of FIG. 8D, the second reference probability is 0.2, falling into the second range. Thus, the second element is selected for remaining as dense data. The value of the second element is updated to the result of dividing the original value of the second element by the pruning probability of the second element. The result of the division is 15. Thus, a vector 846 including values of 0,15, and 0 is obtained.

The two selected elements remain as dense data for the vector 845. A four-element vector 848 including values of 0, 15, 20, and 0 is obtained. The number of dense values (i.e., non-zero values) in the vector 845 is reduced from four to two. Even though FIG. 8D shows the pruning of the vector 845, the process 804 may include pruning of other vectors extracted from the deep learning tensor 840, which may use the same 2:4 sparsity method or a different method, such as the methods described below in conjunction with FIGS. 8A, 8C, and 8D. In some embodiments, half of the values in the deep learning tensor 840 can be pruned based on the 2:4 sparsity ratio. As the deep learning tensor 840 becomes smaller, the memory and compute footprints needed for computing the deep learning tensor 840 can be reduced and therefore, the training or execution of the DNN can be accelerated.

FIG. 9 illustrates another process 900 of pruning a deep learning tensor 910 with a 1:2 sparsity method, in accordance with various embodiments. The process 900 may be performed by the compression module 430, e.g., based on a sparsity ratio of 1:2. The deep learning tensor 910 is a 3D matrix where a plurality of values is arranged. The values may be weights, activations, gradients, or other types of parameters of a DNN. In embodiments where the deep learning tensor 910 is an activation tensor, the deep learning tensor 810 may be the input tensor 210 or the output tensor 230 in FIG. 2. In embodiments where the deep learning tensor 910 is a weight tensor, the deep learning tensor 910 may be the filter 220 in FIG. 2.

The deep learning tensor 910 includes a plurality of subtensors 915A-915D (collectively referred to as “subtensors 915” or “subtensor 915”). The subtensors 915 may be processed by a compute block (e.g., the compute block 325) in four different cycles or by multiple compute blocks in one or more cycles. The MAC array in one compute block may be limited to process the whole deep learning tensor 910 in a single cycle. In other embodiments, the deep learning tensor 910 may include a different number of subtensors 915.

A matrix 920 is extracted from the deep learning tensor 910. The matrix 920 includes two columns and four rows. Each row comes from a different subtensor 915. The number of columns is equal to the second pruning parameter in the sparsity ratio. The norms of the columns are determined. As shown in FIG. 9, the first column has a norm of 9, and the second column has a norm of 12. Then pruning probabilities of the two columns are determined based on the norms. The pruning probability of the first column is 0.4, i.e., 9 divided by the sum of 9 and 12. The pruning probability of the first column is 0.6, i.e., 12 divided by the sum of 9 and 12. Two ranges may be determined: one range is from 0 to 0.4 (including 0.4), i.e., the pruning probability of the first column; and the other range is from 0.4 to 1 (excluding 0.4 but including 1). As the reference probability is 0.5, it falls in to the second range. Thus, the first column will be pruned and become sparse, and the second column will remain dense.

In some embodiments, all the four values in the first column are changed to zero. The values in the second column are updated to keep the unbiasedness or to minimize biasedness. For example, for each respective value in the second column, a new value is determined by dividing the original value by the pruning probability of the second column, i.e., 0.6. The original value is then replaced with the new value. As shown in FIG. 9, each value in the second column is increased. For the purpose of simplicity and illustration, the new values are represented by whole numbers and have zero decimal place in FIG. 9.

The number of dense values (i.e., non-zero values) in the matrix 920 is reduced from eight to four. Even though FIG. 9 shows the pruning of the matrix 920, the process 900 may include pruning of other matrices extracted from the deep learning tensor 910. In some embodiments, half of the values in the deep learning tensor 910 can be pruned based on the 1:2 sparsity ratio. As the deep learning tensor 910 becomes smaller, the memory and compute footprints needed for computing the deep learning tensor 910 can be reduced and therefore, the training or execution of the DNN can be accelerated.

### Example Methods of Compressing DNN

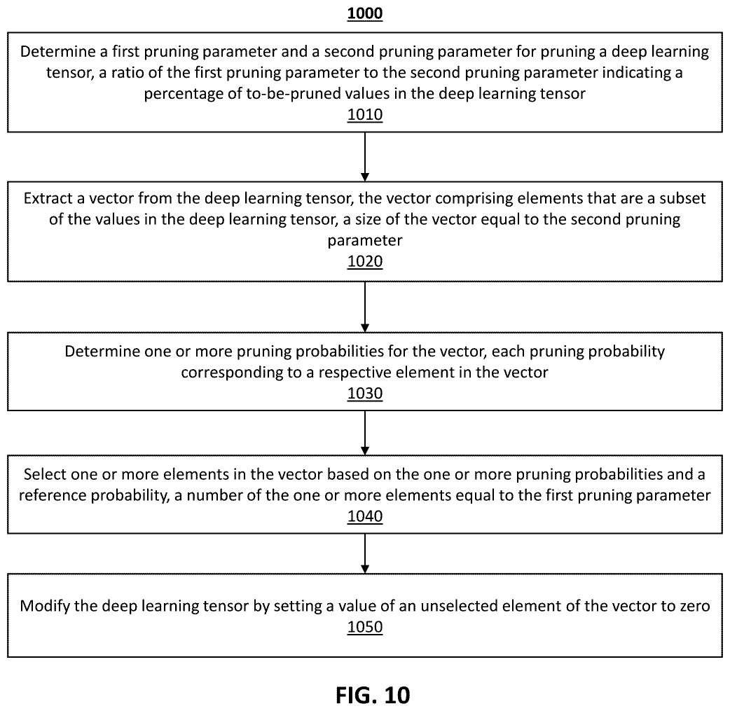

FIG. 10 is a flowchart showing a method 1000 of compressing a DNN, in accordance with various embodiments. The method 1000 may be performed by the compression module 430 in FIG. 4. Although the method 1000 is described with reference to the flowchart illustrated in FIG. 10, many other methods for compressing a DNN may alternatively be used. For example, the order of execution of the steps in FIG. 10 may be changed. As another example, some of the steps may be changed, eliminated, or combined.

The compression module 430 determines 1010 a first pruning parameter and a second pruning parameter for pruning a deep learning tensor. The deep learning tensor may comprise values to be used for a deep learning operation in the DNN. Examples of the deep learning operation include convolutions, pooling operations, elementwise operations, linear operations, non-linear operations, other types of deep learning operations, or some combination thereof. A ratio of the first pruning parameter to the second pruning parameter indicates a percentage of to-be-pruned values in the deep learning tensor. In some embodiments, the first pruning parameter is an integer that is equal to or greater than one, and the second pruning parameter is an integer that is greater than the first pruning parameter.

The compression module 430 extracts 1020 a vector from the deep learning tensor. The vector comprises elements that are a subset of the values in the deep learning tensor. A size of the vector is equal to the second pruning parameter.

The compression module 430 determines 1030 one or more pruning probabilities for the vector. Each pruning probability corresponds to a respective element in the vector. In some embodiments, the compression module 430 determines a total value of the vector by accumulating values of the elements in the vector. The compression module 430 determines a pruning probability of an element in the vector based on a value of the element and the total value of the vector.

The compression module 430 selects 1040 one or more elements in the vector based on the one or more pruning probabilities and a reference probability. A number of the one or more elements is equal to the first pruning parameter. In some embodiments, the compression module 430 selects the elements based on a comparison of at least one of the one or more pruning probabilities and the reference probability. In an embodiment, the compression module 430 may determine whether a pruning probability of an element is greater than the reference probability. The compression module 430 may select the element based on a determination that the pruning probability of the selected element is greater than the reference probability.

In some embodiments, the compression module 430 may form a first subvector and a second subvector from the vector. The first subvector or the second subvector may be a subset of the vector. The first subvector includes at least two elements in the vector, the second subvector includes at least two other elements in the vector. The compression module 430 may select a first element from the first subvector based on pruning probabilities of the at least two elements and the reference probability. The compression module 430 may also select a second element from the second subvector based on pruning probabilities of the at least two other elements and the reference probability. In some embodiments, the at least two elements have a first value and a second value, and the at least two other elements have values between the first value and the second value.

In other embodiments, the compression module 430 may select a first element from the elements in the vector based on the one or more pruning probabilities and the reference probability. The compression module 430 may determine one or more new pruning probabilities based on other elements than the first element in the vector. The compression module 430 may further select a second element from the other elements based on the one or more new pruning probabilities and the reference probability.

The compression module 430 modifies 1050 the deep learning tensor by setting a value of an unselected element of the vector to zero. In some embodiments, the compression module 430 modifies the deep learning tensor further by increasing an absolute value of the selected element. For instance, the compression module 430 divides the absolute value of the element by the pruning probability of the element. The compression module 430 may use the result of the division as the new absolute value of the element. The compression module 430 may keep the sign of the element unchanged. In some embodiments, the deep learning operation is to be performed using the deep learning tensor after the deep learning tensor is modified.

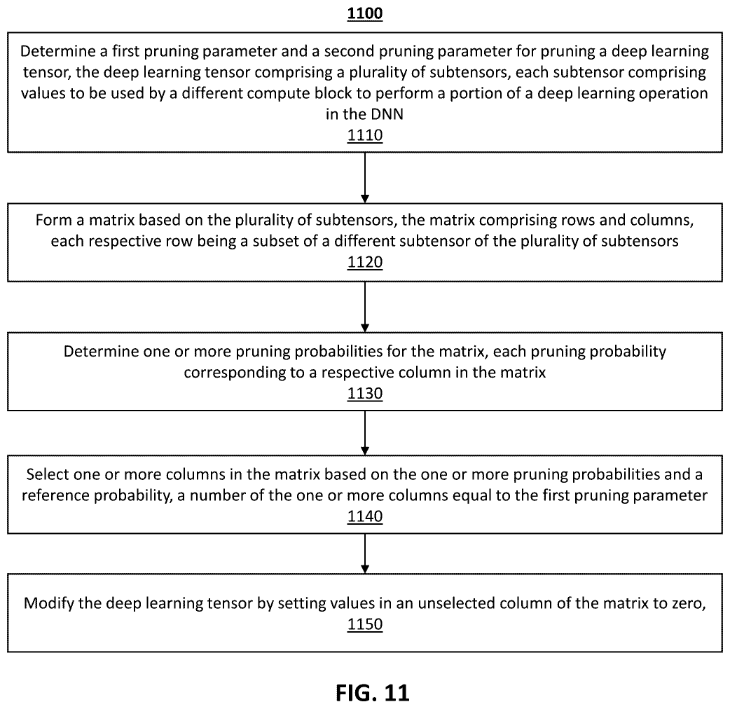

FIG. 11 is a flowchart showing a method 1100 of compressing a DNN, in accordance with various embodiments. The method 1100 may be performed by the compression module 430 in FIG. 5. Although the method 1100 is described with reference to the flowchart illustrated in FIG. 11, many other methods for compressing a DNN may alternatively be used. For example, the order of execution of the steps in FIG. 11 may be changed. As another example, some of the steps may be changed, eliminated, or combined.

The compression module 430 determines 1110 a first pruning parameter and a second pruning parameter for pruning a deep learning tensor. The deep learning tensor comprises a plurality of subtensors. Each subtensor comprises values to be used by a different compute block to perform a portion of a deep learning operation in the DNN. Examples of the deep learning operation include convolutions, pooling operations, elementwise operations, linear operations, non-linear operations, other types of deep learning operations, or some combination thereof. A ratio of the first pruning parameter to the second pruning parameter indicates a percentage of to-be-pruned values in the deep learning tensor.

The compression module 430 forms 1120 a matrix based on the plurality of subtensors. The matrix comprises rows and columns. Each respective row is a subset of a different subtensor of the plurality of subtensors and has a size equal to the second pruning parameter. In some embodiments, the first pruning parameter is an integer that is equal to or greater than one, and the second pruning parameter is an integer that is greater than the first pruning parameter.

The compression module 430 determines 1130 one or more pruning probabilities for the matrix. Each pruning probability corresponds to a respective column in the matrix. In some embodiments, the compression module 430 determines a total norm of the matrix by accumulating norms of the columns in the matrix. The compression module 430 determines a pruning probability of a column in the matrix based on a norm of the column and the total norm of the matrix.

The compression module 430 selects 1140 one or more columns in the matrix based on the one or more pruning probabilities and a reference probability. The number of the one or more columns is equal to the first pruning parameter. In some embodiments, the compression module 430 selects the one or more columns based on a comparison of at least one of the one or more pruning probabilities and the reference probability. In an embodiment, the compression module 430 may determine whether a pruning probability of a column is greater than the reference probability. The compression module 430 may select the column based on a determination that the pruning probability of the column is greater than the reference probability.

In some embodiments, the compression module 430 may form a first submatrix and a second submatrix from the matrix. The first submatrix or second submatrix may be a subset of the matrix. The first submatrix includes at least two columns in the matrix, the second submatrix includes at least two other columns in the matrix. The compression module 430 may select a first column from the first submatrix based on pruning probabilities of the at least two columns and the reference probability. The compression module 430 may also select a second column from the second submatrix based on pruning probabilities of the at least two other columns and the reference probability. In some embodiments, the at least two columns have a first value and a second value, and the at least two other columns have values between the first value and the second value.

In other embodiments, the compression module 430 may select a first column from the columns in the matrix based on the one or more pruning probabilities and the reference probability. The compression module 430 may determine one or more new pruning probabilities based on other columns than the first column in the matrix. The compression module 430 may further select a second column from the other columns based on the one or more new pruning probabilities and the reference probability.

The compression module 430 modifies 1150 the deep learning tensor by setting values of an unselected column of the matrix to zero. In some embodiments, the compression module 430 modifies the deep learning tensor further by changing values of a selected column. For instance, the compression module 430 divides each value of the selected column by the pruning probability of the column. The compression module 430 may use the results of the division as the new values of the column. In some embodiments, the deep learning operation is to be performed using the deep learning tensor after the deep learning tensor is modified.

### Example Computing Device

FIG. 12 is a block diagram of an example computing device 1200, in accordance with various embodiments. In some embodiments, the computing device 1200 may be used as at least part of the DNN system 300 in FIG. 3. A number of components are illustrated in FIG. 12 as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 12, but the computing device 1200 may include interface circuitry for coupling to the one or more components. For example, the computing device 1200 may not include a display device 1206, but may include display device interface circuitry (e.g., a connector and driver circuitry) to which a display device 1206 may be coupled. In another set of examples, the computing device 1200 may not include an audio input device 1218 or an audio output device 1208, but may include audio input or output device interface circuitry (e.g., connectors and supporting circuitry) to which an audio input device 1218 or audio output device 1208 may be coupled.

The computing device 1200 may include a processing device 1202 (e.g., one or more processing devices). The processing device 1202 processes electronic data from registers and/or memory to transform that electronic data into other electronic data that may be stored in registers and/or memory. The computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1204 may include memory that shares a die with the processing device 1202. In some embodiments, the memory 1204 includes one or more non-transitory computer-readable media storing instructions executable to perform operations for compressing DNNs, e.g., the method 1000 described above in conjunction with FIG. 10, the method 1100 described above in conjunction with FIG. 11, or some operations performed by the compression module 430 described above in conjunction with FIGS. 4 and 5. The instructions stored in the one or more non-transitory computer-readable media may be executed by the processing device 1202.

In some embodiments, the computing device 1200 may include a communication chip 1212 (e.g., one or more communication chips). For example, the communication chip 1212 may be configured for managing wireless communications for the transfer of data to and from the computing device 1200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1212 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1212 may operate in accordance with other wireless protocols in other embodiments. The computing device 1200 may include an antenna 1222 to facilitate wireless communications and/or to receive other wireless communications (such as AM or FM radio transmissions).

In some embodiments, the communication chip 1212 may manage wired communications, such as electrical, optical, or any other suitable communication protocols (e.g., the Ethernet). As noted above, the communication chip 1212 may include multiple communication chips. For instance, a first communication chip 1212 may be dedicated to shorter-range wireless communications such as Wi-Fi or Bluetooth, and a second communication chip 1212 may be dedicated to longer-range wireless communications such as global positioning system (GPS), EDGE, GPRS, CDMA, WiMAX, LTE, EV-DO, or others. In some embodiments, a first communication chip 1212 may be dedicated to wireless communications, and a second communication chip 1212 may be dedicated to wired communications.

The computing device 1200 may include battery/power circuitry 1214. The battery/power circuitry 1214 may include one or more energy storage devices (e.g., batteries or capacitors) and/or circuitry for coupling components of the computing device 1200 to an energy source separate from the computing device 1200 (e.g., AC line power).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include another output device 1210 (or corresponding interface circuitry, as discussed above). Examples of the other output device 1210 may include an audio codec, a video codec, a printer, a wired or wireless transmitter for providing information to other devices, or an additional storage device.

The computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1200 may have any desired form factor, such as a handheld or mobile computer system (e.g., a cell phone, a smart phone, a mobile internet device, a music player, a tablet computer, a laptop computer, a netbook computer, an ultrabook computer, a PDA (personal digital assistant), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1200 may be any other electronic device that processes data.

### SELECT EXAMPLES

The following paragraphs provide various examples of the embodiments disclosed herein.

Example 1 provides a method for compressing a DNN, including determining a first pruning parameter and a second pruning parameter for pruning a deep learning tensor, a ratio of the first pruning parameter to the second pruning parameter indicating a percentage of to-be-pruned values in the deep learning tensor; extracting a vector from the deep learning tensor, the vector including elements that are a subset of the values in the deep learning tensor, a size of the vector equal to the second pruning parameter; determining one or more pruning probabilities for the vector, each pruning probability corresponding to a respective element in the vector; selecting one or more elements in the vector based on the one or more pruning probabilities and a reference probability, a number of the one or more elements equal to the first pruning parameter; and modifying the deep learning tensor by setting a value of an unselected element of the vector to zero.

Example 2 provides the method of example 1, where determining the one or more pruning probabilities for the vector includes determining a total value of the vector by accumulating values of the elements in the vector; and determining a pruning probability of an element in the vector based on a value of the element and the total value of the vector.

Example 3 provides the method of example 1 or 2, where selecting the one or more elements in the vector based on the one or more pruning probabilities and the reference probability includes selecting the one or more elements based on a comparison of at least one of the one or more pruning probabilities and the reference probability.

Example 4 provides the method of example 3, where selecting the one or more elements based on the comparison of at least one of the one or more pruning probabilities and the reference probability includes determining whether a pruning probability of an element is greater than the reference probability; and selecting the element based on a determination that the pruning probability of the element is greater than the reference probability.

Example 5 provides the method of example 4, further including modifying the deep learning tensor further by increasing an absolute value of the selected element.

Example 6 provides the method of example 5, where increasing the absolute value of the element includes dividing the absolute value of the element by the pruning probability of the element.

Example 7 provides the method of any of the preceding examples, where selecting the one or more elements in the vector includes forming a first subvector and a second subvector from the vector, the first subvector including at least two elements in the vector, the second subvector including at least two other elements in the vector; selecting a first element from the first subvector based on pruning probabilities of the at least two elements and the reference probability; and selecting a second element from the second subvector based on pruning probabilities of the at least two other elements and the reference probability.

Example 8 provides the method of example 7, where the at least two elements have a first value and a second value, and the at least two other elements have values between the first value and the second value.

Example 9 provides the method of any of the preceding examples, where selecting the one or more elements in the vector includes selecting a first element from the elements in the vector based on the one or more pruning probabilities and the reference probability; determining one or more new pruning probabilities based on other elements than the first element in the vector; and selecting a second element from the other elements based on the one or more new pruning probabilities and the reference probability.

Example 10 provides the method of any of the preceding examples, where the first pruning parameter is an integer that is equal to or greater than one, and the second pruning parameter is an integer that is greater than the first pruning parameter.

Example 11 provides one or more non-transitory computer-readable media storing instructions executable to perform operations for compressing a DNN, the operations including determining a first pruning parameter and a second pruning parameter for pruning a deep learning tensor, a ratio of the first pruning parameter to the second pruning parameter indicating a percentage of to-be-pruned values in the deep learning tensor; extracting a vector from the deep learning tensor, the vector including elements that are a subset of the values in the deep learning tensor, a size of the vector equal to the second pruning parameter; determining one or more pruning probabilities for the vector, each pruning probability corresponding to a respective element in the vector; selecting one or more elements in the vector based on the one or more pruning probabilities and a reference probability, a number of the one or more elements equal to the first pruning parameter; and modifying the deep learning tensor by setting a value of an unselected element of the vector to zero.

Example 12 provides the one or more non-transitory computer-readable media of example 11, where determining the one or more pruning probabilities for the vector includes determining a total value of the vector by accumulating values of the elements in the vector; and determining a pruning probability of an element in the vector based on a value of the element and the total value of the vector.

Example 13 provides the one or more non-transitory computer-readable media of example 11 or 12, where selecting the one or more elements in the vector based on the one or more pruning probabilities and the reference probability includes selecting the one or more elements based on a comparison of at least one of the one or more pruning probabilities and the reference probability.

Example 14 provides the one or more non-transitory computer-readable media of example 13, where selecting the one or more elements based on the comparison of at least one of the one or more pruning probabilities and the reference probability includes determining whether a pruning probability of an element is greater than the reference probability; and selecting the element based on a determination that the pruning probability of the element is greater than the reference probability.

Example 15 provides the one or more non-transitory computer-readable media of example 14, where the operations further include modifying the deep learning tensor further by increasing an absolute value of the selected element.

Example 16 provides the one or more non-transitory computer-readable media of example 15, where increasing the absolute value of the element includes dividing the absolute value of the element by the pruning probability of the element.

Example 17 provides the one or more non-transitory computer-readable media of any one of examples 11-16, where selecting the one or more elements in the vector includes forming a first subvector and a second subvector from the vector, the first subvector including at least two elements in the vector, the second subvector including at least two other elements in the vector; selecting a first element from the first subvector based on pruning probabilities of the at least two elements and the reference probability; and selecting a second element from the second subvector based on pruning probabilities of the at least two other elements and the reference probability.

Example 18 provides the one or more non-transitory computer-readable media of example 17, where the at least two elements have a first value and a second value, and the at least two other elements have values between the first value and the second value.

Example 19 provides the one or more non-transitory computer-readable media of any one of examples 11-18, where selecting the one or more elements in the vector includes selecting a first element from the elements in the vector based on the one or more pruning probabilities and the reference probability; determining one or more new pruning probabilities based on other elements than the first element in the vector; and selecting a second element from the other elements based on the one or more new pruning probabilities and the reference probability.

Example 20 provides the one or more non-transitory computer-readable media of any one of examples 11-19, where the first pruning parameter is an integer that is equal to or greater than one, and the second pruning parameter is an integer that is greater than the first pruning parameter.

Example 21 provides an apparatus, including a computer processor for executing computer program instructions; and a non-transitory computer-readable memory storing computer program instructions executable by the computer processor to perform operations including determining a first pruning parameter and a second pruning parameter for pruning a deep learning tensor, a ratio of the first pruning parameter to the second pruning parameter indicating a percentage of to-be-pruned values in the deep learning tensor, extracting a vector from the deep learning tensor, the vector including elements that are a subset of the values in the deep learning tensor, a size of the vector equal to the second pruning parameter, determining one or more pruning probabilities for the vector, each pruning probability corresponding to a respective element in the vector, selecting one or more elements in the vector based on the one or more pruning probabilities and a reference probability, a number of the one or more elements equal to the first pruning parameter, and modifying the deep learning tensor by setting a value of an unselected element of the vector to zero.

Example 22 provides the apparatus of example 21, where determining the one or more pruning probabilities for the vector includes determining a total value of the vector by accumulating values of the elements in the vector; and determining a pruning probability of an element in the vector based on a value of the element and the total value of the vector.

Example 23 provides the apparatus of example 21 or 22, where selecting the one or more elements in the vector based on the one or more pruning probabilities and the reference probability includes selecting the one or more elements based on a comparison of at least one of the one or more pruning probabilities and the reference probability.

Example 24 provides the apparatus of any one of examples 21-23, where selecting the one or more elements in the vector includes forming a first subvector and a second subvector from the vector, the first subvector including at least two elements in the vector, the second subvector including at least two other elements in the vector; selecting a first element from the first subvector based on pruning probabilities of the at least two elements and the reference probability; and selecting a second element from the second subvector based on pruning probabilities of the at least two other elements and the reference probability.

Example 25 provides the apparatus of any one of examples 21-24, where selecting the one or more elements in the vector includes selecting a first element from the elements in the vector based on the one or more pruning probabilities and the reference probability; determining one or more new pruning probabilities based on other elements than the first element in the vector; and selecting a second element from the other elements based on the one or more new pruning probabilities and the reference probability.

### ADDITIONAL SELECT EXAMPLES

Example 1 provides a method for compressing a DNN, including determining a first pruning parameter and a second pruning parameter for pruning a deep learning tensor, the deep learning tensor including a plurality of subtensors, each subtensor including values to be used by a different compute block to perform a portion of a deep learning operation in the DNN, a ratio of the first pruning parameter to the second pruning parameter indicating a percentage of to-be-pruned values in the deep learning tensor; forming a matrix based on the plurality of subtensors, the matrix including rows and columns, each respective row being a subset of a different subtensor of the plurality of subtensors; determining one or more pruning probabilities for the matrix, each pruning probability corresponding to a respective column in the matrix; selecting one or more columns in the matrix based on the one or more pruning probabilities and a reference probability, a number of the one or more columns equal to the first pruning parameter; and modifying the deep learning tensor by setting values in an unselected column to zero.

Example 2 provides the method of example 1, where determining the one or more pruning probabilities for the matrix includes determining a total norm by accumulating norms of the columns in the matrix; and determining a pruning probability of a column in the matrix based on a norm of the column and the total norm.

Example 3 provides the method of example 1 or 2, where selecting the one or more columns in the matrix based on the one or more pruning probabilities and a reference probability includes selecting the one or more columns based on a comparison of at least one of the one or more pruning probabilities and the reference probability.

Example 4 provides the method of example 3, where selecting the one or more columns based on the comparison of at least one of the one or more pruning probabilities and the reference probability includes determining whether a pruning probability of a column is greater than the reference probability; and selecting the column based on a determination that the pruning probability of the column is greater than the reference probability.

Example 5 provides the method of example 4, further including modifying the deep learning tensor further by changing values of the column.

Example 6 provides the method of example 5, where changing the values of the column includes for each respective value of the column: determining a new value by dividing by the respective value by the pruning probability of the column; and replacing the respective value with the new value.

Example 7 provides the method of any of the preceding examples, where selecting the one or more columns in the matrix includes forming a first submatrix and a second submatrix from the matrix, the first submatrix including at least two columns in the matrix, the second submatrix including at least two other columns in the matrix; selecting a first column from the first submatrix based on pruning probabilities of the at least two columns and the reference probability; and selecting a second column from the second submatrix based on pruning probabilities of the at least two other columns and the reference probability.

Example 8 provides the method of example 7, where the at least two columns have a first norm and a second norm, and the at least two other columns have norm s between the first norm and the second norm.

Example 9 provides the method of any of the preceding examples, where selecting the one or more columns in the matrix includes selecting a first column from the columns in the matrix based on the one or more plurality of pruning probabilities and the reference probability; determining one or more new pruning probabilities based on other columns than the first column in the matrix; and selecting a second column from the other columns based on the one or more new pruning probabilities and the reference probability.

Example 10 provides the method of any of the preceding examples, where the first pruning parameter is an integer that is equal to or greater than one, and the second pruning parameter is an integer that is greater than the first pruning parameter.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method for compressing a deep neural network (DNN), comprising:
determining a first pruning parameter and a second pruning parameter for pruning a deep learning tensor, a ratio of the first pruning parameter to the second pruning parameter indicating a percentage of to-be-pruned values in the deep learning tensor;
extracting a vector from the deep learning tensor, the vector comprising elements that are a subset of the values in the deep learning tensor, a size of the vector equal to the second pruning parameter;
determining one or more pruning probabilities for the vector, each pruning probability corresponding to a respective element in the vector;
selecting one or more elements in the vector based on the one or more pruning probabilities and a reference probability, a number of the one or more elements equal to the first pruning parameter; and
modifying the deep learning tensor by setting a value of an unselected element of the vector to zero.

2. The method of claim 1, wherein determining the one or more pruning probabilities for the vector comprises:
determining a total value of the vector by accumulating values of the elements in the vector; and
determining a pruning probability of an element in the vector based on a value of the element and the total value of the vector.

3. The method of claim 1, wherein selecting the one or more elements in the vector based on the one or more pruning probabilities and the reference probability comprises:
selecting the one or more elements based on a comparison of at least one of the one or more pruning probabilities and the reference probability.

4. The method of claim 3, wherein selecting the one or more elements based on the comparison of at least one of the one or more pruning probabilities and the reference probability comprises:
determining whether a pruning probability of an element is greater than the reference probability; and
selecting the element based on a determination that the pruning probability of the element is greater than the reference probability.

5. The method of claim 4, further comprising:
modifying the deep learning tensor further by increasing an absolute value of the selected element.

6. The method of claim 5, wherein increasing the absolute value of the element comprises:
dividing the absolute value of the element by the pruning probability of the element.

7. The method of claim 1, wherein selecting the one or more elements in the vector comprises:
forming a first subvector and a second subvector from the vector, the first subvector comprising at least two elements in the vector, the second subvector comprising at least two other elements in the vector;
selecting a first element from the first subvector based on pruning probabilities of the at least two elements and the reference probability; and
selecting a second element from the second subvector based on pruning probabilities of the at least two other elements and the reference probability.

8. The method of claim 7, wherein the at least two elements have a first value and a second value, and the at least two other elements have values between the first value and the second value.

9. The method of claim 1, wherein selecting the one or more elements in the vector comprises:
selecting a first element from the elements in the vector based on the one or more pruning probabilities and the reference probability;
determining one or more new pruning probabilities based on other elements than the first element in the vector; and
selecting a second element from the other elements based on the one or more new pruning probabilities and the reference probability.

10. The method of claim 1, wherein the first pruning parameter is an integer that is equal to or greater than one, and the second pruning parameter is an integer that is greater than the first pruning parameter.

11. One or more non-transitory computer-readable media storing instructions executable to perform operations for compressing a deep neural network (DNN), the operations comprising:
determining a first pruning parameter and a second pruning parameter for pruning a deep learning tensor, a ratio of the first pruning parameter to the second pruning parameter indicating a percentage of to-be-pruned values in the deep learning tensor;
extracting a vector from the deep learning tensor, the vector comprising elements that are a subset of the values in the deep learning tensor, a size of the vector equal to the second pruning parameter;
determining one or more pruning probabilities for the vector, each pruning probability corresponding to a respective element in the vector;
selecting one or more elements in the vector based on the one or more pruning probabilities and a reference probability, a number of the one or more elements equal to the first pruning parameter r; and
modifying the deep learning tensor by setting a value of an unselected element of the vector to zero.

12. The one or more non-transitory computer-readable media of claim 11, wherein determining the one or more pruning probabilities for the vector comprises:
determining a total value of the vector by accumulating values of the elements in the vector; and
determining a pruning probability of an element in the vector based on a value of the element and the total value of the vector.

13. The one or more non-transitory computer-readable media of claim 11, wherein selecting the one or more elements in the vector based on the one or more pruning probabilities and the reference probability comprises:
selecting the one or more elements based on a comparison of at least one of the one or more pruning probabilities and the reference probability.

14. The one or more non-transitory computer-readable media of claim 13, wherein selecting the one or more elements based on the comparison of at least one of the one or more pruning probabilities and the reference probability comprises:
determining whether a pruning probability of an element is greater than the reference probability; and
selecting the element based on a determination that the pruning probability of the element is greater than the reference probability.

15. The one or more non-transitory computer-readable media of claim 14, wherein the operations further comprise:
modifying the deep learning tensor further by increasing an absolute value of the selected element.

16. The one or more non-transitory computer-readable media of claim 15, wherein increasing the absolute value of the element comprises:
dividing the absolute value of the element by the pruning probability of the element.

17. The one or more non-transitory computer-readable media of claim 11, wherein selecting the one or more elements in the vector comprises:
forming a first subvector and a second subvector from the vector, the first subvector comprising at least two elements in the vector, the second subvector comprising at least two other elements in the vector;
selecting a first element from the first subvector based on pruning probabilities of the at least two elements and the reference probability; and
selecting a second element from the second subvector based on pruning probabilities of the at least two other elements and the reference probability.

18. The one or more non-transitory computer-readable media of claim 17, wherein the at least two elements have a first value and a second value, and the at least two other elements have values between the first value and the second value.

19. The one or more non-transitory computer-readable media of claim 11, wherein selecting the one or more elements in the vector comprises:
selecting a first element from the elements in the vector based on the one or more pruning probabilities and the reference probability;
determining one or more new pruning probabilities based on other elements than the first element in the vector; and
selecting a second element from the other elements based on the one or more new pruning probabilities and the reference probability.

20. The one or more non-transitory computer-readable media of claim 11, wherein the first pruning parameter is an integer that is equal to or greater than one, and the second pruning parameter is an integer that is greater than the first pruning parameter.

21. An apparatus, comprising:
a computer processor for executing computer program instructions; and
a non-transitory computer-readable memory storing computer program instructions executable by the computer processor to perform operations comprising:
determining a first pruning parameter and a second pruning parameter for pruning a deep learning tensor, a ratio of the first pruning parameter to the second pruning parameter indicating a percentage of to-be-pruned values in the deep learning tensor,
extracting a vector from the deep learning tensor, the vector comprising elements that are a subset of the values in the deep learning tensor, a size of the vector equal to the second pruning parameter,
determining one or more pruning probabilities for the vector, each pruning probability corresponding to a respective element in the vector,
selecting one or more elements in the vector based on the one or more pruning probabilities and a reference probability, a number of the one or more elements equal to the first pruning parameter, and
modifying the deep learning tensor by setting a value of an unselected element of the vector to zero.

22. The apparatus of claim 21, wherein determining the one or more pruning probabilities for the vector comprises:
determining a total value of the vector by accumulating values of the elements in the vector; and
determining a pruning probability of an element in the vector based on a value of the element and the total value of the vector.

23. The apparatus of claim 21, wherein selecting the one or more elements in the vector based on the one or more pruning probabilities and the reference probability comprises:
selecting the one or more elements based on a comparison of at least one of the one or more pruning probabilities and the reference probability.

24. The apparatus of claim 21, wherein selecting the one or more elements in the vector comprises:
forming a first subvector and a second subvector from the vector, the first subvector comprising at least two elements in the vector, the second subvector comprising at least two other elements in the vector;
selecting a first element from the first subvector based on pruning probabilities of the at least two elements and the reference probability; and
selecting a second element from the second subvector based on pruning probabilities of the at least two other elements and the reference probability.

25. The apparatus of claim 21, wherein selecting the one or more elements in the vector comprises:
selecting a first element from the elements in the vector based on the one or more pruning probabilities and the reference probability;
determining one or more new pruning probabilities based on other elements than the first element in the vector; and
selecting a second element from the other elements based on the one or more new pruning probabilities and the reference probability.
